(19) United States
(12) Patent Application Publication
(10) Pub. No.: US 2025/0268290 A1
(43) Pub. Date: Aug. 28, 2025

(54) MULTI-COMPONENT SYSTEM FOR PREPARING PLANT-BASED SAUCES AND/OR SOUPS

(71) Applicant: Herbstreith & Fox GmbH & Co. KG Pektin-Fabriken, Neuenbürg (DE)

(72) Inventors: SVEN F0X, Neuenbürg (DE); JENS PUHL, Werder (DE)

(21) Appl. No.: 18/039,757

(22) PCT Filed: Dec. 3, 2021
(86) PCT No.: PCT/EP2021/084173

§ 371 Date: Oct. 12, 2023

(30) Foreign Application Priority Data
Dec. 4, 2020 (DE) 10 2020 132 293.3

(51) Int. Cl. A23L 23/10; A23L 27/60; A23L 29/231

(52) U.S. Cl. CPC A23L 23/10; A23L 27/60; A23L 29/231

(57) ABSTRACT

The present invention relates to a multi-component system for the preparation of a sauce or a soup comprising a base component, a fine texture component and optionally a refining component. The invention further relates to the use of the multi-component system for the production of a sauce or soup, a sauce or soup produced from this multi-component system, and a method for producing the sauce and/or soup by means of the multi-component system according to the invention.

The present invention relates to a multi-component system for preparing a sauce or a soup, a use of the multi-component system for preparing a sauce or soup, a sauce or soup prepared from said multi-component system, and a method for preparing the sauce and/or soup by means of the multi-component system according to the invention.

### BACKGROUND OF THE INVENTION

In gastronomy and the food industry, the taste of many dishes is determined by the sauce contained in the dish. Depending on the desired taste, a wide variety of sauces are used, which are prepared on the basis of different components. While in the high-end catering industry each sauce is freshly prepared from scratch, in the low-cost segment pre-made sauces are regularly used. When prepared from scratch, the desired flavor can be precisely determined, but preparation is time-consuming and costly and requires trained personnel. Pre-prepared complete sauces, on the other hand, have the disadvantage that they are regularly not optimally adapted in terms of taste to the dish being offered. This can result in an unsatisfactory taste experience. Furthermore, pre-made sauces often have a high salt and calorie content.

In addition to these two approaches, it is also possible for some sauces to modify the flavor of the sauce via further additives, depending on the specific application, starting from a basic sauce. The concept of the basic sauce originates from the classic cuisine of France and has been established in gastronomy for a long time. Here, a basic sauce is refined by adding seasonings, flavoring ingredients and other foods to achieve the desired flavor. A base sauce is produced from the main ingredients bones, broths, stocks, root vegetables, tomatoes, tomato paste, flour, butter, milk or cream in a complex process.

The aromatic liquids used, such as funds, wines, oils or dairy products, usually already determine the flavor, which can then only be modified to a limited extent. Thus, base sauces are limited to a small number of applications and have only a limited range of possible flavor variations. In addition, the production of such base sauces is demanding and requires the use of trained personnel. The consistency of the base sauce can be varied by thickening with roux, starch, egg or cold butter. Here, the exact dosage and the specific procedure are important, so that experienced personnel are also required for thickening.

WO 00/70971 A1 describes a combination of a dry spice mixture containing a buffer and/or an alkaline substance with an acidified, emulsified sauce mixture with a very high salt and solids content. This combination is said to be particularly stable against microbiological attack. However, a disadvantage of the combination described in WO 00/70971 A1 is the high salt content, which is generally considered to be harmful to health.

EP 0 653 166 A1 describes a viscous sauce containing 10-60% fat, 0.1-2% alkyl cellulose and 0.1-3% thickener and having a pH of less than 5. This viscous sauce can be modified in taste by adding butter, vegetables, spices, wine and the like. Here, the range of flavors is limited in particular by the high fat content. In addition, only a few types of particularly viscous sauces can be produced using this approach.

Thus, there is still a need for a sauce system that can be used to produce a wide variation of different sauces in a simple, cost-effective and flexible manner.

A similar problem arises in the area of soups, where there are also significant differences in quality and time of preparation between a freshly made soup and an instant soup.

The objective of the present invention thus is to provide a system with which a wide range of different sauces and soups can be prepared in an uncomplicated manner.

This objective is solved with the multi-component system according to claim 1, the use according to claim 18, the sauce or soup according to claim 19, and the method according to claim 23.

### SUMMARY OF THE INVENTION

According to a first aspect of the present invention, the task is accomplished by a multi-component system for the preparation of sauces and/or soups comprising as separate components:
a. a base component comprising a liquid binder,
b. a fine texture component, and
c. optionally a refining component.

The multi-component system according to the invention is suitable for the production of a wide range of different sauces and soups. The base component forms the basis of the sauce or soup and provides a basic structure and preferably a basic taste. The fine texture component is then used to determine the fine texture of the sauce or soup. The flexible combination of the base component with the fine texture component allows a wide range of different-tasting sauces and/or soups with varying consistencies to be produced in a variable manner.

The multi-component system allows easy, fast and flexible preparation of different sauces and soups.

In a sense, the multi-component system according to the invention provides a construction kit that can be combined with potentially hundreds of fine textures based on selected basic sauces. In this way, a handful of basic sauces based on the classic basic sauces of the culinary art (béchamel, velouté, espagnole and hollandaise) can be given innumerable taste characteristics in the fine texture. The basic sauces can be freely combined with the fine texture, thus creating an infinite number of flavor combinations. Ultimately, thousands of combinations are possible from which the cook/user can choose. The multi-component combination thus provides a solution which, on the one hand, can be used quickly and easily as a “convenience” food, but which, in the combination of the base component with the fine texture component, but especially through the refinement with the refinement component, also raises the sauces from a “convenient” sauce to an individual sauce, while still remaining easy and quick to produce.

The multi-component system is not only suitable for “professional users”/gastronomy, but also as a “ready-to-use” kit for the end user as a normal consumer (for example, a base component plus 5 fine texture flavors in one set).

It can thus be sold not only in wholesale, but also in food retail or online.

### Base Component

The multi-component system according to the invention for the production of sauces and/or soups contains a base component comprising a binder for liquids, such as water. This binder will also be referred to as “liquid binder” for short in the following. This base component binds the water and gives the sauce and/or soup its basic consistency.

According to a preferred embodiment of the multicomponent system according to the invention, the base component contains a liquid binder selected from the group consisting of xanthan gum, starch, starch flours, plant fiber, in particular pectin-containing plant fiber, locust bean gum, guar gum, carubin, konjac, agar, carrageenan, algin, cellulose, alkyl cellulose, in particular methyl cellulose, ethyl cellulose, hydroxypropyl cellulose, hydroxypropyl methyl cellulose, methylethyl cellulose, carboxymethyl cellulose or sodium carboxymethyl cellulose, pectin and mixtures thereof. Such liquid binders are excellent for giving basic structure and basic consistency to the sauce or soup.

According to an advantageous embodiment of the invention, the liquid binder contained in the base component has a water-binding capacity of more than 15 g/g, 18 g/g, 19 g/g, preferably of more than 20 g/g, preferably of more than 22 g/g and particularly preferably of more than 23 g/g, the amount of water that can be bound by one gram of binder being indicated here in grams. Such a high water binding capacity, however, only allows a rough adjustment of the viscosity of the sauce or soup, since the viscosity and the texture depend on many factors, such as the solid content of the liquid to be textured.

Particularly preferably, the base component contains a plant fiber as liquid binder. Plant fibers are very suitable as liquid binders because they have a particularly high water-binding capacity. In addition, plant fibers have some decisive advantages over the hydrocolloids usually contained in sauces or soups. Hydrocolloids clump together during the cooking process due to the formation of long-chain hydrocolloid strands. This can lead to burning at the heat source and skin formation on the surface of the sauce or soup. To prevent this, a sauce or soup containing hydrocolloids as liquid binders must be stirred regularly and heated gently. Regular stirring ties up personnel and/or requires expensive equipment. Slow and careful heating makes the manufacturing process less efficient and can result in longer wait times for guests. These problems are solved by using plant fibers as liquid binders. The plant fibers do not form complex strands and do not cause clumping. Thus, a sauce or soup according to the invention, of which the base component contains plant fiber as a liquid binder, can be boiled more quickly and in a more efficient manner. Due to the short bond of the plant fiber, the surface of the liquid thickened with it does not dry out and does not crust as with hydrocolloids, so that the water can evaporate unhindered and thus no skin formation occurs. Furthermore, plant fibers have the advantage that they lead to a better, i.e. unadulterated, flavor release. In contrast, hydrocolloids as binders lead to masking of the flavor. In this case, the flavoring ingredients, in particular, are strongly reduced in flavor perception, so that in the case of hydrocolloids as binders, attempts are often made to compensate for this flavor masking by increasing the salt content.

It is particularly advantageous if the plant fiber used as water binder in the base component is native. In this context, native means that the plant fiber has not been previously sheared in water. If the water binder contained in the base component is a native plant fiber, the base component has a particularly high water-binding capacity, and the swelling process of the fibers is also particularly fast and insensitive to temperature.

Conventional binding systems, if not cooked out properly, can result in post-thickening. For flour, the boiling time is approx. 30 min., for starch 10-15 min. This must also be done in order to boil out the inherent flavor of the binding system. The native plant fiber as a component of the base component always has a constant viscosity after the correct swelling time. Even when the product cools down, the viscosity remains stable over the entire temperature spectrum. There is no need for adding water again, for mixing to break the hydrocolloid chains, or for long boiling times and precise dosing.

The multi-component system can also be used cold when plant fibers are used due to the capillary action of these dietary fibers. It can be stirred in without lumps and is thus an almost fully adequate cold binder substitute. In the prior art, this usually requires the use of cold-swelling and other chemically modified products specifically designed for these properties. Hydrocolloids, unless modified, always require heat treatment for reaction. In addition, traditional binding systems contain a hard fat component for better handling, which must first be made to melt.

The invention can thus be used as a texturizer (curd, yogurt, fruit puree, cold dishes) even at low temperatures, thus preserving the ingredients and the taste. Furthermore, in the neutral version, the invention is suitable for “rescuing” and giving neutral viscosity to purees such as mashed potatoes, mashed celery or pure vegetable purees, to which potatoes or other starchy products are usually added to create an appropriate consistency.

The multi-component system is cold portionable and well reversible when plant fibers are used. Preparing and portioning warm food and then cooling it down is also possible. There is also no solution here so far, as previous binding systems are designed for either cold or hot applications. Due to the solidified hydrocolloid chains in a cold state, careful heating and constant stirring have been necessary up to now to avoid scorching. Regeneration with hydrocolloid systems often produces an unsightly skin and the edges dry out.

It is further advantageous if the plant fiber is a protopectin-containing plant fiber with a significant proportion of water-soluble pectin. The proportion of water-soluble pectin can be between 2 and 10 wt %. It can thus be, for example, 3 wt %, 4 wt %, 5 wt %, 6 wt %, 7 wt %, 8 wt % or 9 wt %. Because of this proportion of water-soluble pectin, the fiber is also referred to as pectin-containing fiber in the context of the application. Such plant fibers have proven to be particularly well suited for binding water.

Preferably, the plant fiber is selected from the group consisting of citrus fiber, apple fiber, sugar beet fiber, carrot fiber and pea fiber, wherein the plant fiber is preferably a fruit fiber and particularly preferably a pectin-containing activatable citrus fiber or a pectin-containing activatable apple fiber. Such plant fibers can be obtained inexpensively and exhibit excellent water binding properties.

According to a preferred embodiment of the multi-component system according to the invention, the base component has a basic flavor direction. With this basic flavor direction, the base component already provides a discreet basic direction for the flavor of the sauce or soup, which can, however, still be modified variably by the other components of the sauce or soup.

A basic flavor of the base component can be achieved by the base component containing, in addition to the liquid binder, a flavor component selected from the group consisting of vegetable powder, for example celery powder, carrot powder, onion powder, leek powder, garlic powder, tomato powder, beetroot powder and mixtures thereof, milk powder, cream powder and mixtures thereof. Particularly preferably, the base flavor is based on the classic base sauces already known to the skilled person from French cuisine. Possible base flavors can be described here as light base sauce, dark base sauce and tomato sauce. A base component with the base flavor “dark base sauce” preferably contains vegetable powder. A base component with the base flavor “light base sauce” preferably contains vegetable powder, milk powder and cream powder. A base component with the basic flavor “tomato sauce” preferably contains tomato powder.

According to a further preferred embodiment of the invention, the base component also contains ingredients from the group consisting of spices, salt, natural flavorings and mixtures thereof. With these further ingredients, the base component can be optimally rounded off in terms of flavor.

The various constituents may be present in widely varying proportions in the base component a. To ensure that the sauce or soup has good consistency and viscosity, it has proved advantageous if the base component contains from 1 to 99 wt %, preferably from 2 to 80 wt %, more preferably from 5 to 60 wt %, further preferably from 10 to 45 wt % and particularly preferably from 15 to 40 wt % of water binders, in each case based on the total weight of the dry base component a.

According to a further preferred embodiment of the invention, the base component a. contains 10 to 90 wt %, preferably 15 to 85 wt %, preferably 20 to 80 wt % or particularly preferably 25 to 75 wt % of flavor component, in each case based on the total weight of the dry base component a. This proportion of flavor component in the base component a. is ideal for adjusting the basic flavor.

In addition, it is advantageous for health reasons if the salt content of the base component a. is kept low. Preferably, the base component a. contains between 5 wt % and 10 wt % salt, in each case based on the total weight of the dry base component a. The fact that only a quantity of 45 to 75 g of base component per liter of soup or sauce has to be used for the production of the sauce or soup thus results in final salt contents of less than 5 g salt/liter. Conventional sauce powders also contain 5 to 10 wt %, but due to the higher basic input of sauce powder of more than 100 g/liter, they result in salt contents of more than 10 g or even more than 15 g salt/liter of sauce. The present invention makes it possible to use up to 66% less salt (=5.0 g instead of up to 15.0 g salt/liter) than in commercially available products while maintaining the same salt perception for the guest.

In a preferred embodiment of the invention, the base component a. is a solid, in particular a powder. In this way, the base component a. can be dosed particularly well.

Further, the base component a. is preferably substantially free of water, so that the swelling behavior of the liquid binder is particularly effective. In this context, “substantially free of water” means that the water content is less than 5 wt %, advantageously less than 1 wt %, in particular less than 0.5 wt %, preferably less than 0.3 wt %, more preferably less than 0.2 wt %, more preferably less than 0.1 wt % and particularly preferably less than 0.05 wt %, in each case based on the total weight of the base component a.

### The Activatable Pectin-Containing Citrus Fiber

In a preferred embodiment, an activatable pectin-containing citrus fiber is used as the liquid binder for the base component a. By using acidic disintegration as a process step during manufacturing, the fiber structure can be disintegrated and this structure maintained accordingly by subsequent alcoholic washing steps and gentle drying.

In the acidic extraction step, the pectin content of the citrus fiber has been reduced substantially so that the activatable pectin-containing citrus fiber contains less than 10 wt %, preferably less than 8 wt % and particularly preferably less than 6 wt % of water-soluble pectin. Thus, the content of water-soluble pectin in this citrus fiber can be, for instance, 2 wt %, 3 wt %, 4 wt %, 5 wt %, 6 wt %, 7 wt %, 8 wt %, 9 wt % or 9.5 wt %. This residual pectin is a high methoxyl pectin. According to the invention, a high methoxyl pectin is a pectin which has a degree of esterification of at least 50%. The degree of esterification is the percentage of carboxylic groups in the galacturonic acid chains of the pectin which are present in esterified form, e. g. as methyl esters. The degree of esterification can be determined with the method according to JECFA (Monograph 19-2016, Joint FAO/WHO Expert Committee on Food Additives).

In an advantageous embodiment, the activatable pectin-containing citrus fiber has, in a 4 wt % aqueous suspension, a firmness of between 60 g and 240 g, preferably between 120 g and 200 g and particularly preferably of between 140 and 180 g.

The activatable pectin-containing citrus fiber advantageously has a water binding capacity of more than 20 g/g, preferably more than 22 g/g, particularly preferably of more than 24 g/g and most preferably between 24 and 26 g/g. Such an advantageously high water binding capacity leads to a high viscosity and consequently also to a lower fiber consumption with a creamy texture.

In one embodiment, the activatable pectin-containing citrus fiber has a yield point II (rotation) of 0.1-1.0 Pa, advantageously 0.3-0.9 Pa and particularly preferably 0.6-0.8 Pa. In case of a fiber dispersion, the activatable pectin-containing citrus fiber correspondingly has a yield point I (rotation) of 1.0-4.0 Pa, advantageously 1.5-3.5 Pa and particularly preferably 2.0-3.0 Pa.

According to another embodiment, the activatable pectin-containing citrus fiber has a yield point II (cross-over) of 0.1-1.0 Pa, advantageously 0.3-0.9 Pa and particularly preferably 0.6-0.8 Pa in a 2.5 wt % suspension. In case of a fiber dispersion, the activatable pectin-containing citrus fiber has a yield point I (cross-over) of 1.0-4.5 Pa, advantageously 1.5-4.0 Pa and particularly advantageously 2.0-3.5 Pa.

In one embodiment, the activatable pectin-containing citrus fiber has a dynamic Weissenberg number in a 2.5 wt % fiber suspension of 4.5-8.0, advantageously 5.0-7.5 and particularly advantageously more than 7.0-7.5. After shearing activation, the activatable pectin-containing citrus fiber accordingly has a dynamic Weissenberg number in a 2.5 wt % fiber dispersion of 5.0-9.0, advantageously 6.0-8.5 and particularly advantageously 7.0-8.0.

For the activatable pectin-containing citrus fiber the features of the three previous paragraphs can also be combined in any permutation, if desired. Thus, in a specific embodiment, the pectin-containing citrus fiber according to the invention can have all features of the three previous paragraphs, wherein this pectin-containing citrus fiber preferably is obtainable or is obtained by the preparation method described in the following.

For determining the yield point I (rotation), yield point I (cross-over) and the dynamic Weissenberg number in a 2.5 wt % dispersion, the activatable pectin-containing citrus fiber is dispersed according to the method disclosed in the examples as a 2.5 wt % solution; measurement takes place after 1 h at 20° C.

For determining the yield point II (rotation), yield point II (cross-over) and the dynamic Weissenberg number in a 2.5 wt % suspension, the activatable pectin-containing citrus fiber is suspended according to the method disclosed in the examples as a 2.5 wt % solution; measurement takes place after 1 h at 20° C.

Preferably, the activatable pectin-containing citrus fiber has a viscosity of between 150 and 600 mPas, preferably 200 to 550 mPas and particularly preferably 250 to 500 mPas, wherein the activatable pectin-containing citrus fiber is dispersed in water as a 2.5 wt % solution and the viscosity is measured with a shear rate of 50 s⁻¹ at 20° C.

For determining viscosity, the activatable pectin-containing citrus fiber is dispersed in demineralized water with the method disclosed in the examples as a 2.5 wt % solution, and viscosity is determined at 20° C. and four shearing sections (first and third section=constant profile; second and fourth section=linear ramp; each evaluation at a shearing speed of 50 s⁻¹) (rheometer; Physica MCR series, measuring bob CC25 [corresponding to Z3 DIN], Anton Paar company, Graz, Austria). The advantage of a pectin-containing citrus fiber with such a high viscosity is that a lower amount of fiber is necessary for thickening the final product. In addition, the fiber thus creates a creamy texture.

According to one embodiment, the activatable pectin-containing citrus fiber has a moisture of less than 15 wt %, preferably less than 10 wt % and particularly preferably less than 8 wt %.

It is also preferable for the activatable pectin-containing citrus fiber to have, in a 1.0 wt % aqueous suspension, a pH value of 3.1 to 4.75 and preferably 3.4 to 4.2.

The activatable pectin-containing citrus fiber advantageously has a particle size in which at least 90 wt % of the particles are smaller than 450 μm, preferably smaller than 350 μm and particularly preferably smaller than 250 μm.

In one advantageous embodiment, the activatable pectin-containing citrus fiber has a lightness value of L*>84, preferably L*>86 and particularly preferably L*>88. Thus, the citrus fibers are nearly colorless and do not cause any coloring worth mentioning when they are employed in food products.

Advantageously, the activatable pectin-containing citrus fiber has a dietary fiber content of 80 to 95 wt %.

The activatable pectin-containing citrus fiber used according to the invention is preferably present in powder form. The advantage is that in this manner, there is a formulation with low weight and long shelf life which is also easy to employ in process technology. This formulation is only made possible by the activatable pectin-containing citrus fiber used according to the invention and which, other than modified starches, does not tend to lump formation when it is dissolved in liquids.

### Production of the Activatable Pectin-Containing Citrus Fiber

The activatable pectin-containing citrus fiber is obtainable by a method comprising the following steps:
(a) providing a raw material which contains the cell wall material of an edible citrus fruit;
(b) disintegrating the raw material by incubation of an aqueous suspension of the raw material at an acidic pH value;
(c) one- or multi-stage separation of the disintegrated material from step (b) from the aqueous suspension;
(d) washing of the material separated in step (c) with an aqueous solution and separation of coarse or non-disintegrated particles;
(e) separating the washed material from step (d) from the aqueous solution;
(f) washing the separated material from step (e) at least twice with an organic solvent and subsequently separating the washed material from the organic solvent;
(g) optionally additionally removing the organic solvent by contacting the washed material respectively from step (f) with water vapor;
(h) drying the material from step (f) or (g), comprising drying at normal pressure to obtain the activatable pectin-containing citrus fiber.

This production method results in citrus fibers with a large interior surface, which also increases the water binding capacity and contributes to a good viscosity formation.

These fibers are activatable fibers which have sufficient firmness due to partial activation during the preparation process. For obtaining optimum rheological properties, such as viscosity or texturing, however, additional shear forces need to be applied by the user. Thus, these are also partially activated fibers that are further activatable.

The inventors have found the citrus fibers produced with this method to have good rheological properties. The fibers according to the invention can be easily rehydrated, and the advantageous rheological properties are maintained even after rehydration.

The production method results in citrus fibers which are to a large degree free of smell and taste and consequently advantageous for use in the food area. The intrinsic flavor of the other ingredients is not masked and can therefore develop in an optimum manner.

As raw material, citrus fruits, and preferably processing residues of citrus fruits, can be employed. The raw material to be used in the method described herein may be citrus peel (albedo and/or flavedo), citrus vesicles, segment membranes or a combination thereof. Preferably, citrus pulp is used as the raw material, i. e. the press residues of citrus fruits, which typically also contain the fruit flesh in addition to the peels.

All citrus fruits known to the person skilled in the art can be used herein. As non-limiting examples, the following are mentioned: tangerine (Citrus reticulata), clementine (Citrus x aurantium clementine group; syn.: Citrus clementina), satsuma (Citrus x aurantium satsuma group; syn.: Citrus unshiu), mangshan (Citrus mangshanensis), orange (Citrus x aurantium orange group; syn.: Citrus sinensis), bitter orange (Citrus x aurantium bitter orange group), bergamot (Citrus x limon bergamot group; syn.: Citrus bergamia), shaddock (Citrus maxima), Grapefruit (Citrus x aurantium grapefruit group; syn.: Citrus paradisi), pomelo (Citrus x aurantium pomelo group), key lime (Citrus x aurantiifolia), persian lime (Citrus x aurantiifolia; syn.: Citrus latifolia), kaffir lime (Citrus hystrix), rangpur lime (Citrus x jambhiri), lemon (Citrus x limon lemon group), citron (Citrus medica) and kumquats (Citrus japonica; syn.: Fortunella). Orange (Citrus x aurantium orange group; syn.: Citrus sinensis) and lemon (Citrus x limon lemon group) are preferred.

The acidic disintegration in step (b) of the method is used to remove pectin by converting the protopectin into soluble pectin and at the same time activating the fiber by enlargement of the interior surface. Furthermore, the raw material is thermally comminuted by the disintegration. Due to acidic incubation in the aqueous environment, with the application of heat, it disintegrates into citrus fibers. In this way, thermal comminution is achieved; mechanical comminution is not necessary within the framework of this production method. This is a substantial advantage over conventional fiber production methods which, in contrast, require a shearing step (for instance [high] pressure homogenization) in order to obtain a fiber with sufficient rheological properties.

Acid disintegration as process step (b) in the manufacturing process allows the fiber structure to be broken down, and subsequent alcoholic washing steps with gentle drying can maintain this structure accordingly.

Due to the acid extraction step, the activatable pectin-containing citrus fiber has less than 10 wt %, preferably less than 8 wt % and particularly preferably less than 6 wt % of water-soluble pectin. Advantageously, the activatable, pectin-containing citrus fiber has a water-soluble pectin content of between 2 wt % and 8 wt %, and particularly preferably between 2 and 6 wt %. The water-soluble pectin content in this citrus fiber may be, for example, 2 wt %, 3 wt %, 4 wt %, 5 wt %, 6 wt %, 7 wt %, 8 wt %, 9 wt % or 9.5 wt %.

During the disintegration according to step (b), the raw material is an aqueous suspension. A suspension according to the invention is a heterogeneous mixture of a liquid and solids (raw material particles) finely distributed therein. Since the suspension tends to sedimentation and separation of phases, the particles are suitably kept in suspension by shaking or stirring. That is, there is no dispersion, which would mean that the particles are mechanically comminuted (shearing) so as to be finely dispersed.

To achieve an acidic pH value in step (b), the person skilled in the art may employ all acids or acidic buffering solutions that are known to him. For instance, an organic acid, such as citric acid, can be used.

Alternatively or in combination, a mineral acid may be used. Some examples are sulfuric acid, hydrochloric acid, nitric acid or sulfurous acid. Preferably, nitric acid is employed.

In acidic disintegration according to step (b) of the method, the pH value of the suspension is between pH=0.5 and pH=4.0, preferably between pH=1.0 and pH=3.5 and particularly preferably between pH=1.5 and pH=3.0.

According to the invention, the liquid for producing the aqueous suspension consists of more than 50 vol %, preferably more than 60, 70, 80 or even 90 vol %, of water. In a preferred embodiment, the liquid contains no organic solvent and in particular no alcohol. Thus, the process is a water-based acidic extraction.

In one embodiment, the production method, and in particular the acidic disintegration in step (b), do not involve enzymatic treatment of the raw material by addition of an enzyme, in particular no amylase treatment.

In the acidic disintegration in step (b), the incubation takes place at a temperature between 60° C. and 95° C., preferably between 70° C. and 90° C., and particularly preferably between 75° C. and 85° C.

The incubation in step (b) takes place between 60 min to 8 hours, and preferably between 2 to 6 hours.

In acidic disintegration according to step (b), the aqueous suspension suitably has a dry mass of between 0.5 wt % and 5 wt %, preferably of between 1 wt % and 4 wt %, and particularly preferably of between 1.5 wt % and 3 wt %.

During disintegration in step (b), the aqueous suspension is stirred or shaken. This is preferably done continuously to keep the particles in suspension.

In step (c) of the method, the disintegrated material is separated from the aqueous solution and thus recovered. This separation takes place in one or more stages.

Advantageously, the disintegrated material is subjected to multi-stage separation according to step (c). Preferably, increasingly finer particles are separated stepwise from the aqueous suspension. This means that, for example, in case of two-stage separation, both stages separate larger particles from the solution, with the second stage separating off finer particles than the first stage so as to achieve as complete a separation of the particles from the aqueous suspension as possible. Preferably, the first separation is done by means of decanters and the second one by means of separators. Thus, the particles forming the material become finer with each separation stage.

After acidic disintegration in step (b) and separation of the disintegrated material in step (c), the separated material is washed with an aqueous solution in step (d). In this step, remaining water-soluble substances, such as e. g. sugars, can be removed. Especially the removal of sugar in this step contributes to lesser adhesion of the citrus fiber, which makes it easier to process and to use.

Within the context of this invention, “aqueous solution” is intended to indicate the aqueous liquid employed for washing in step (d). The mixture of this aqueous solution and the disintegrated material is called “washing mixture”.

Advantageously, washing according to step (d) is performed with water as an aqueous solution. The use of deionised water is particularly preferred.

In one embodiment, the aqueous solution consists of more than 50 vol %, preferably more than 60, 70, 80 or even 90 vol %, of water. In a preferred embodiment, the aqueous solution contains no organic solvent and in particular no alcohol. Thus, washing is water-based and does not lead to an exchange of water and alcohol as is the case in fiber washing with a mixture of alcohol and water, wherein the mixture has more than 50 vol % of alcohol, typically more than 70 vol % of alcohol.

Alternatively, a saline solution with an ionic strength of I<0.2 mol/l can be used as the aqueous solution.

Washing according to step (d) advantageously takes place at a temperature between 30° C. and 90° C., preferably between 40° C. and 80° C. and particularly preferably between 50° C. and 70° C.

Contacting with the aqueous solution in step (d) takes place between 10 min to 2 hours, preferably between 30 min to one hour.

During washing according to step (d), the dry mass in the washing mixture amounts to between 0.1 wt % and 5 wt %, preferably between 0.5 wt % and 3 wt % and particularly preferably between 1 wt % and 2 wt %.

Advantageously, washing according to step (d) is performed with mechanical movement of the washing mixture. This is expediently done by stirring or shaking of the washing mixture.

During washing according to step (d), a separation of larger or non-disintegrated particles takes place. This separation of particles takes place within the framework of separation of the washed material from the washing liquid. The separation of particles with a size of more than 500 μm, more preferably more than 400 μm and most preferably more than 350 μm is particularly advantageous. Separation advantageously is done with a straining machine or a belt press. In this manner, both coarse particular impurities of the raw material and insufficiently disintegrated material are removed.

After washing with the aqueous solution in step (d), the washed material is separated from the aqueous solution according to step (e). This separation advantageously takes place by means of a decanter or a separator.

In step (f), an additional washing step takes place; this time, however, with an organic solvent. Washing with organic solvent is done at least twice.

The organic solvent can also be a mixture of the organic solvent and water, wherein this mixture contains more than 50 vol % and preferably more than 70 vol % of organic solvent.

The organic solvent in step f) is advantageously an alcohol which can be selected from the group consisting of methanol, ethanol and isopropanol.

The washing step according to step (f) takes place at a temperature between 40° C. and 75° C., preferably between 50° C. and 70° C. and particularly preferably between 60° C. and 65° C.

Contacting with the organic solvent in step (f) takes place between 60 min to 10 hours, preferably between 2 hours to 8 hours.

Each step of washing with the organic solvent comprises contacting the material with the organic solvent for a specific duration of time, followed by separation of the material from the organic solvent. For this separation, preferably a decanter or a press is used.

During washing with the organic solvent in step (f), the dry mass in the washing solution amounts to between 0.5 wt % and 15 wt %, preferably between 1.0 wt % and 10 wt % and particularly preferably between 1.5 wt % and 5.0 wt %.

Washing with organic solvent according to step (f) is preferably performed with mechanical movement of the washing mixture. This is preferably done in a tank with a stirring unit.

For washing with the organic solvent in step (f), advantageously a device for homogenization of the suspension is used. This device is preferably a toothed ring disperser.

According to an advantageous embodiment, washing with the organic solvent in step (f) takes place in a counterflow procedure.

In one embodiment, partial neutralization by addition of Na or K salts, NaOH or KOH, takes place during washing in step (f) with the organic solvent.

During washing with the organic solvent in step (f), decoloring of the material can also be performed. This decoloring may take place by the addition of one or more oxidants. For instance, the oxidants could be chlorine dioxide and hydrogen peroxide, which may be used by themselves or in combination.

In an advantageous embodiment, during the at least two-fold washing with an organic solvent, the concentration of the organic solvent in the solution increases with each washing step. By this incremental increase in organic solvent, the portion of water in the fiber material is reduced in a controlled manner such that the rheological properties of the fibers are maintained during the subsequent steps of solvent removal and drying and the partially activated fiber structure does not collapse.

Preferably, the final concentration of the organic solvent amounts to between 60 and 70 vol % in the first washing step, between 70 and 85 vol % in the second washing step, and in an optional third washing step, between 80 and 90 vol %.

In the optional step (g), the solvent content can additionally be reduced by contacting the material with water vapor. This is preferably done by means of a stripper in which the material is contacted with water vapor as the stripping gas in countercurrent.

In an advantageous embodiment, the material is moisturized with water before drying according to step (h). This is preferably done by introduction of the material in a moisturization screw and spraying with water.

In step (h), the washed material from step (f) or the stripped material from step (g) are dried, wherein the drying comprises a drying under normal pressure. Examples of suitable drying methods are fluid bed drying, fluidized-bed drying, belt drying, drum drying or paddle drying. Fluidized-bed drying is particularly preferred. The advantage of fluidized-bed drying is that the product is dried in a loose condition which simplifies the subsequent comminution step. In addition, this type of drying avoids damage to the product by local overheating since the input of heat can be dosed very well.

Drying under normal pressure in step (h) advantageously takes place at a temperature between 50° C. and 130° C., preferably between 60° C. and 120° C. and particularly preferably between 70° C. and 110° C. After drying, the product is advantageously cooled to ambient temperature.

In an advantageous embodiment, the method additionally comprises a comminution, milling or sieving step after drying in step (h). This step is advantageously performed such that as a result, 90 wt % of the particles have a size of less than 450 μm, preferably less than 350 μm and particularly preferably less than 250 μm. At this particle size, the fiber is well dispersible and has optimum swelling properties.

The activatable pectin-containing citrus fiber used according to the invention as well as a method to the production thereof, are disclosed in the application DE 10 2020 122 510.5.

### The Activatable Pectin-Containing Apple Fiber

In a preferred embodiment, an activatable pectin-containing apple fiber is used as the liquid binder for the base component a. By using acidic disintegration as a process step during manufacturing, the fiber structure can be disintegrated and this structure maintained accordingly by subsequent alcoholic washing steps and gentle drying. Within the context of the application, the activated pectin-containing apple fiber is synonymously also called “pectin-containing apple fiber”.

In the acidic extraction step, the pectin content of the apple fiber has been reduced substantially so that the activatable pectin-containing apple fiber contains less than 10 wt %, preferably less than 8 wt % and particularly preferably less than 6 wt % of water-soluble pectin. The content of water-soluble pectin in this activatable pectin-containing apple fiber can be, for instance, 2 wt %, 3 wt %, 4 wt %, 5 wt %, 6 wt %, 7 wt %, 8 wt % or 9 wt %.

The residual water-soluble pectin is a high methoxyl pectin. According to the invention, a high methoxyl pectin is a pectin which has a degree of esterification of at least 50%. The degree of esterification is the percentage of carboxylic groups in the galacturonic acid chains of the pectin which are present in esterified form, e. g. as methyl esters. The degree of esterification can be determined with the method according to JECFA (Monograph 19-2016, Joint FAO/WHO Expert Committee on Food Additives).

In an advantageous embodiment, the activatable pectin-containing apple fiber has a firmness of between 5 g and 100 g, preferably between 20 g and 60 g and particularly preferably of between 30 and 50 g, the activatable pectin-containing apple fiber being an aqueous suspension with a fiber concentration of 6 wt %.

The activatable pectin-containing apple fiber advantageously has a water binding capacity of more than 19 g/g, preferably more than 21 g/g, particularly preferably of more than 23 g/g. Such an advantageously high water binding capacity leads to a high viscosity and consequently also to a lower fiber consumption with a creamy texture.

In one embodiment, the activatable pectin-containing apple fiber has a yield point II (rotation) of 0.1-1.0 Pa, advantageously 0.15-0.75 Pa and particularly preferably 0.25-0.5 Pa in a 2.5 wt % suspension. In case of a 2.5 wt % dispersion, the activatable pectin-containing apple fiber correspondingly has a yield point I (rotation) of 0.75-3.75 Pa, advantageously 1.0-3.5 Pa and particularly advantageously 1.25-3.25 Pa.

According to another embodiment, the activatable pectin-containing apple fiber has a yield point II (cross-over) of 0.1-1.0 Pa, advantageously 0.15-0.75 Pa and particularly advantageously 0.25-0.5 Pa in a 2.5 wt % suspension. In a 2.5 wt % dispersion, the activatable pectin-containing apple fiber has a yield point I (cross-over) of 0.75-4.25 Pa, advantageously 1.5-4.0 Pa and particularly advantageously 1.75-3.75 Pa.

In one embodiment, the activatable pectin-containing apple fiber has a dynamic Weissenberg number in a 2.5 wt % fiber suspension of 3.0 Pa to 7.0 Pa, advantageously 3.5 Pa to 6.5 Pa and particularly advantageously 4.5 Pa to 6.0 Pa. After shearing activation, the activatable pectin-containing apple fiber accordingly has a dynamic Weissenberg number in a 2.5 wt % fiber dispersion of 4.0 Pa to 7.5 Pa, advantageously 4.5 Pa to 7.0 Pa and particularly advantageously 5.0 Pa to 6.5 Pa.

To determine the yield point I (rotation), yield point I (cross over) and dynamic Weissenberg number in the fiber dispersion, the apple fiber is dispersed in demineralized water as a 2.5 wt % solution using the method disclosed in the examples.

To determine the yield point Rotation II, yield point Cross Over II and dynamic Weissenberg number in the fiber suspension, the apple fiber is suspended in demineralized water using the method disclosed in the examples as a 2.5 wt % solution.

Preferably, the activatable pectin-containing apple fiber has a viscosity of between 50 and 350 mPas, preferably 75 to 200 mPas and particularly preferably 100 to 150 mPas, wherein the activatable pectin-containing apple fiber is dispersed in water as a 2.5 wt % solution and the viscosity is measured with a shear rate of 50 s⁻¹ at 20° C.

For determining viscosity, the activatable pectin-containing apple fiber is dispersed in demineralized water with the method disclosed in the examples as a 2.5 wt % solution, and viscosity is determined at 20° C. and four shearing sections (first and third section=constant profile; second and fourth section=linear ramp; each measurement at a shearing speed of 50 s⁻¹) (rheometer; Physica MCR series, measuring bob CC25 [corresponding to Z3 DIN], Anton Paar company, Graz, Austria). The advantage of an activatable pectin-containing apple fiber with such a high viscosity is that a lower amount of fiber is necessary for thickening the final product. In addition, the fiber thus creates a creamy texture.

According to one embodiment, the activatable pectin-containing apple fiber has a moisture of less than 15 wt %, preferably less than 10 wt % and particularly preferably less than 8 wt %.

It is also preferable for the activatable pectin-containing apple fiber to have, in a 1.0 wt % aqueous suspension, a pH value of 3.5 to 5.0 and preferably 4.0 to 4.6.

The activatable pectin-containing apple fiber advantageously has a particle size in which at least 90 wt % of the particles are smaller than 450 μm, preferably smaller than 350 μm and particularly preferably smaller than 250 μm.

In one advantageous embodiment, the activatable pectin-containing apple fiber has a lightness value of L*>54, preferably L*>55 and particularly preferably L*>56. At such a lightness value, the apple fiber exhibits a slight brown coloration, which makes it particularly suitable for dark sauces or soups and represents added value here. In this case, the use of the apple fiber in the base component and/or the fine texture component can also be used to specifically adjust the coloration and adapt it to the type of sauce or soup (such as in a saffron-salmon sauce).

Advantageously, the activatable pectin-containing apple fiber has a dietary fiber content of 80 to 95 wt %.

The activatable pectin-containing apple fiber used according to the invention preferably exists in powder form. The advantage is that in this manner, a formula with low weight and high storage stability is provided which can also be easily employed in terms of process technology. This formula is only made possible by the apple fiber used according to the invention which, other than modified starches, does not tend to form lumps when it is stirred into liquids.

### Production of the Activatable Pectin-Containing Apple Fiber

The activatable pectin-containing apple fiber is obtainable by a method comprising the following steps:
(a) providing a raw material which contains the cell wall material of an apple;
(b) disintegrating the raw material by incubation of an aqueous suspension of the raw material at an acidic pH value;
(c) one- or multi-stage separation of coarse particles from the disintegrated material from step (b) in aqueous suspension;
(d) separating the material freed from coarse particles obtained in step (c) from the aqueous suspension;
(e) washing of the material separated in step (d) with an aqueous solution;
(f) separating the washed material in step (e) from the aqueous solution;
(g) washing the separated material from step (f) at least twice with an organic solvent and subsequently separating the washed material from the organic solvent;
(h) optionally additionally removing the organic solvent by contacting the washed material respectively from step (g) with water vapor;
(i) drying the material from step (g) or (h), comprising drying at normal pressure to obtain the activatable pectin-containing apple fiber.

The production method results in apple fibers with a large internal surface, which also increases water-binding capacity and contributes to good viscosity formation.

These fibers are activatable fibers which obtain sufficient firmness by partial activation during the preparation process. For obtaining optimal rheological properties like viscosity or texturing, however, the user also has to employ additional shearing forces. This results in partially activated fibers that are further activatable.

The inventors have found the apple fibers produced with the described method to exhibit good rheological characteristics. The fibers can be easily rehydrated, and the advantageous rheological properties remain even after rehydration.

The production method results in apple fibers which are to a large degree free of smell and taste and consequently advantageous for use in the food area. The intrinsic flavor of the other ingredients is not masked and can therefore develop in an optimum manner.

The apple fibers are obtained from apples, forming natural components with well-known positive characteristics.

The activatable pectin-containing apple fiber can be obtained from all cultivated apples (malus domesticus) known to the person skilled in the art. As starting material, advantageously processing residues of apples can be employed. The starting material may be apple peel, apple core, apple seeds, fruit flesh or a combination thereof. Preferably, apple pomace is used as the raw material, i. e. the press residues of apples, which typically also contain the above-mentioned components in addition to the peels.

The acidic disintegration in step (b) of the method is used to remove pectin by converting the protopectin into soluble pectin and at the same time activating the fiber by enlargement of the interior surface. Furthermore, the raw material is thermally comminuted by the disintegration. Due to acidic incubation in the aqueous environment, with the application of heat, it disintegrates into apple fibers. In this way, thermal comminution is achieved; mechanical comminution is not necessary within the framework of this production method. This is a substantial advantage over conventional fiber production methods which, in contrast, require a shearing step (for instance [high] pressure homogenization) in order to obtain a fiber with sufficient rheological properties.

By using acidic disintegration as a process step during manufacturing, the fiber structure can be disintegrated and this structure maintained accordingly by subsequent alcoholic washing steps and gentle drying.

Due to the acidic extraction step, the activatable apple fiber has a pectin content of less than 10 wt %, preferably less than 8 wt % and particularly preferably less than 6 wt % of water-soluble pectin. The activatable pectin-containing apple fiber advantageously has a content of water-soluble pectin of between 2 wt % and 8 wt % and particularly preferably of between 2 and 6 wt %. The content of water-soluble pectin in this apple fiber can be, for instance, 2 wt %, 3 wt %, 4 wt %, 5 wt %, 6 wt %, 7 wt %, 8 wt %, 9 wt % or 9.5 wt %.

During the disintegration according to step (b), the raw material is an aqueous suspension. A suspension according to the invention is a heterogeneous mixture of a liquid and solids (raw material particles) finely distributed therein. Since the suspension tends to sedimentation and separation of phases, the particles are suitably kept in suspension by shaking or stirring. That is, there is no dispersion, which would mean that the particles are mechanically comminuted (shearing) so as to be finely dispersed.

To achieve an acidic pH value in step (b), the person skilled in the art may employ all acids or acidic buffering solutions that are known to him. For instance, an organic acid, such as citric acid, can be used.

Alternatively or in combination, a mineral acid may be used. Some examples are sulfuric acid, hydrochloric acid, nitric acid or sulfurous acid. Preferably, sulfuric acid is employed.

In acidic disintegration according to step (b) of the method, the pH value of the suspension is between pH=0.5 and pH=4.0, preferably between pH=1.0 and pH=3.5 and particularly preferably between pH=1.5 and pH=3.0.

According to the invention, the liquid for producing the aqueous suspension consists of more than 50 vol %, preferably more than 60, 70, 80 or even 90 vol %, of water. In a preferred embodiment, the liquid contains no organic solvent and in particular no alcohol. Thus, the process is a water-based acidic extraction.

In one embodiment, the production method, and in particular the acidic disintegration in step (b), do not involve enzymatic treatment of the raw material by addition of an enzyme, in particular no amylase treatment.

In the acidic disintegration in step (b), the incubation takes place at a temperature between 60° C. and 95° C., preferably between 70° C. and 90° C., and particularly preferably between 75° C. and 85° C.

The incubation in step (b) takes place over 60 min to 8 hours, and preferably over 2 to 6 hours.

In acidic disintegration according to step (b), the aqueous suspension suitably has a dry mass of between 0.5 wt % and 5 wt %, preferably of between 1 wt % and 4 wt %, and particularly preferably of between 1.5 wt % and 3 wt %.

During disintegration in step (b), the aqueous suspension is advantageously stirred or shaken. This is preferably done continuously to keep the particles in suspension.

In step (c) of the method, the disintegrated material is separated from coarse particles. This separation takes place in one or more steps.

During one- or multi-stage separation in step (c), it is advantageous if particles having a size of more than 1000 μm are separated off. In this manner, both coarse-particle impurities of the raw material and insufficiently disintegrated material are removed.

Advantageously, the disintegrated material is subjected to multi-stage separation according to step (c). Preferably, increasingly finer particles are separated stepwise from the aqueous suspension. This means that, for example, in case of two-stage separation, both stages separate larger particles from the solution, with the second step separating off finer particles than the first stage. Thus, the particles forming the material become finer with each separation stage.

A two-stage separation of particles, with particles having a size of more than 1000 μm being separated in the first step and particles with a size of more than 500 μm being separated in the second step is particularly advantageous in step (c). This two-step separation advantageously takes place by means of a sieve drum, a straining machine or a another means of wet sieving.

After acidic disintegration in step (b), removal of coarse particles in step (c) and separation of the disintegrated material from the aqueous suspension in step (d)—which is preferably done by means of a decanter—, the separated material is washed with an aqueous solution in step (e). In this step, remaining water-soluble substances, such as e. g. sugars, can be removed. Especially the removal of sugar in this step contributes to lesser adhesion of the apple fiber, which makes it easier to process and to use.

Within the context of this invention, “aqueous solution” is intended to indicate the aqueous liquid employed for washing in step (e). The mixture of this aqueous solution and the disintegrated material is called “washing mixture”.

Advantageously, washing according to step (e) is performed with water as an aqueous solution. The use of deionized water is particularly preferred.

In one embodiment, the aqueous solution consists of more than 50 vol %, preferably more than 60, 70, 80 or even 90 vol %, of water. In a preferred embodiment, the aqueous solution contains no organic solvent and in particular no alcohol. Thus, washing is water-based and does not lead to an exchange of water and alcohol as is the case in fiber washing with a mixture of alcohol and water, wherein the mixture has more than 50 vol % of alcohol, typically more than 70 vol % of alcohol.

Alternatively, a saline solution with an ionic strength of I<0.2 mol/l can be used as the aqueous solution.

Washing according to step (e) advantageously takes place at a temperature between 30° C. and 90° C., preferably between 40° C. and 80° C. and particularly preferably between 50° C. and 70° C.

Contacting with the aqueous solution in step (e) takes place between 10 min to 2 hours, preferably between 30 min to one hour.

During washing according to step (e), the dry mass in the washing mixture amounts to between 0.1 wt % and 5 wt %, preferably between 0.5 wt % and 3 wt % and particularly preferably between 1 wt % and 2 wt %.

Advantageously, washing according to step (e) is performed with mechanical movement of the washing mixture. This is expediently done by stirring or shaking of the washing mixture.

After washing with the aqueous solution, the washed material is separated from the aqueous solution according to step (f). This separation advantageously takes place by means of a decanter or a separator.

In step (g), an additional washing step takes place; this time, however, with an organic solvent. Washing with organic solvent is done at least twice.

The organic solvent is advantageously an alcohol which can be selected from the group consisting of methanol, ethanol and isopropanol.

The organic solvent can also be a mixture of the organic solvent and water, wherein this mixture then contains more than 50 vol % and preferably more than 70 vol % of organic solvent.

The washing step according to step (g) takes place at a temperature between 40° C. and 75° C., preferably between 50° C. and 70° C. and particularly preferably between 60° C. and 65° C.

Contacting with the organic solvent takes place between 60 min to 10 hours, preferably between 2 hours and 8 hours.

Each step of washing with the organic solvent comprises contacting the material with the organic solvent for a specific duration of time, followed by separation of the material from the organic solvent. For this separation, preferably a decanter or a press is used.

During washing with the organic solvent in step (g), the dry mass in the washing solution amounts to between 0.5 wt % and 15 wt %, preferably between 1.0 wt % and 10 wt % and particularly preferably between 1.5 wt % and 5.0 wt %.

Washing with organic solvent according to step (g) is preferably performed with mechanical movement of the washing mixture. This is preferably done in a tank with a stirring unit.

For washing with the organic solvent in step (g), advantageously a device for homogenization of the suspension is used. This device is preferably a toothed ring disperser.

According to an advantageous embodiment, washing with the organic solvent in step (g) takes place in a counterflow procedure.

In one embodiment, partial neutralization by addition of Na or K salts, NaOH or KOH takes place during washing with the organic solvent in step (g).

During washing with the organic solvent in step (g), decoloring of the material can also be performed. This decoloring may take place by the addition of one or more oxidants. For instance, the oxidants could be chlorine dioxide and hydrogen peroxide, which may be used by themselves or in combination.

In an advantageous embodiment, during the at least two-fold washing with an organic solvent in step (g), the concentration of the organic solvent in the solution increases with each washing step. By this incremental increase in organic solvent, the portion of water in the fiber material is reduced in a controlled manner such that the rheological properties of the fibers are maintained during the subsequent steps of solvent removal and drying and the partially activated fiber structure does not collapse.

Preferably, the final concentration of the organic solvent amounts to between 60 and 70 vol % in the first washing step, between 70 and 85 vol % in the second washing step, and in an optional third washing step, between 80 and 90 vol %.

In the optional step (h), the portion of solvent can additionally be reduced by contacting the material with water vapor. This is preferably done by means of a stripper in which the material is contacted in countercurrent with water vapor as the stripping gas.

In an advantageous embodiment, the material is moisturized with water before drying according to step (i). This is preferably done by introduction of the material in a moisturization screw and spraying with water.

In step (i), the washed material from step (g) or the stripped material from step (h) are dried, wherein the drying comprises drying under normal pressure. Examples of suitable drying methods are fluid bed drying, fluidized-bed drying, belt drying, drum drying or paddle drying. Fluidized-bed drying is particularly preferred. The advantage is that the product is dried in a loose condition which simplifies the subsequent comminution step. In addition, this type of drying avoids damage to the product by local overheating since the input of heat can be dosed very well.

Drying under normal pressure in step (i) advantageously takes place at a temperature between 50° C. and 130° C., preferably between 60° C. and 120° C. and particularly preferably between 70° C. and 110° C. After drying, the product is advantageously cooled to ambient temperature.

In an advantageous embodiment, the method additionally comprises a comminuting, milling or sieving step after drying in step (i). This step is advantageously performed such that as a result, 90% of the particles have a size of less than 450 μm, preferably less than 350 μm and particularly preferably less than 250 μm. At this particle size, the fiber is well dispersible and has optimum swelling properties.

The activatable pectin-containing apple fiber used according to the invention as well as a method to the production thereof, are disclosed in the application DE 10 2020 115 525.5.

### Fine Texture Component

The fine texture component in the multi-component system according to the invention is responsible for the fine texturing of the sauce and/or soup. In addition, the fine texture component preferably contains the flavor which essentially characterizes the taste of the sauce and/or soup.

The fine texture component exhibits texturizing properties that result in a velvety consistency of the sauce or soup with a glossy appearance due to the fiber properties.

In a particularly preferred embodiment of the multi-component system according to the invention, the fine texture component contains an activated plant fiber as a texturizing component for fine texturing. An activated plant fiber in this case is a plant fiber that has already been activated in the manufacturing process, in particular by means of the use of shear forces. According to the invention, an “activated plant fiber” is a plant fiber that has sufficient firmness so that no additional shear forces are required in the application in order to obtain the optimum rheological properties, such as viscosity or texturing, on the user side.

The above-described activation of the fiber with surface enlargement by shearing thus provides finely divided fibers with liquid-filled capillaries, which can be optimally used for fine texturing, especially as a paste. Such plant fibers also have the advantage of being flavor-neutral.

When used as a paste, the process is in a sense “backwards”, in that the high initial viscosity is reduced by the addition of the fine texture component, but the fine texture is produced as velvety and gloss. Thus, in the specific case of the soup or sauce, up to 25 wt %-30 wt % of fine texture component can be added.

As the inventors have found out, with a very small amount of fine texture component b. in the liquid textured with base component a., surprisingly, even without additional shear, possible roughness can be prevented by reducing the fiber spacing from each other, with filling fine fiber parts by texturing the free water.

This is remarkable because of the comparatively small amount of fine texture component b used in relation to the total amount of liquid to be textured, and thus forms a new basis for fine adjustment of viscosity when using the same basic ingredients.

However, all the desired properties that correspond to the current state of a good sauce are retained. Especially the preservation of the gloss is to be emphasized here. Also, the overall positive effects already known from texturing with plant fibers in the first elaboration (scorch behavior, skin formation) are only fully retained by this combination.

Pretexturing with the base component a. containing plant fibers and subsequent fine texturing with fine texture component b also circumvents a texturing problem that frequently occurs when using native plant fibers. Due to the low amounts of 1.5 wt %-2.0 wt % dry matter/liter for the base component a. containing plant fibers (compared to a conventional hydrocolloid with a Roux of 8.0 wt %-10.0 wt % dry matter/liter), overdosage can quickly occur, which is very inconvenient for the user to rework.

The processing of the viscosity of liquids by texturing in two separate components and the corresponding possibility of successive addition (two separate texturing processing phases building on each other) with the base component a containing plant fibers and the fine texture component b thus enables a high liquid binding and individual fine adjustment. Here, it is particularly advantageous to use the fine texture component b in pasty form, which, due to its pasty state, allows the viscosity to be adjusted—even cold—much more precisely than with prior art texturing agents, and this without additional boiling out or post-swelling.

The invention is thus essentially based on a synergism between the base component a. containing plant fibers and the fine texture component b. containing plant fibers. The base component a. allows an effective and flavor-neutral viscosity build-up of large quantities of liquid and thus a “pre-texturization”. For one liter of liquid, between 1.5 wt % and 2.0 wt % of base component a. is already sufficient to build up a soup or sauce consistency. When using a native plant fiber according to the invention, a rapid binding of the free water can be observed, so that the entire swelling process of the fiber is completed within a few minutes, even in cold liquids, so that the usual post-swelling or, in the case of hydrocolloids, partially necessary “boiling out” is not necessary.

However, the use of a native plant fiber as part of the base component means that the fibers may still have a certain roughness on the tongue and when swallowed in their fully swollen state.

To mitigate this effect, the product is usually subjected to shear forces (mixing rod) to break the surface of the fibers and bypass possible roughness.

However, this creates a pulpy appearance, as in a pure tomato sauce or goulash, which is not desirable in a variety of sauces and also does not correspond to the usual image of a sauce.

Possible roughness can also be concealed by the use of fat, but this is accompanied by a change or concealment of flavor in addition to the considerable increase in calories.

In addition, the shearing process destroys the gloss created by the pectin it contains, which is also a desirable characteristic of a good sauce.

This is where the fine texture component b. comes into play, providing the desired fine texturing without fat or shear, in a simple and controlled manner, without disturbing the positive rheological or sensory properties produced by the base component.

The two components thus work together in a synergistic way, forming the basis for a novel concept for sauce or soup production.

Processes for the production of such activated plant fibers are known to the skilled person. In this process, plant fibers are subjected to shear forces in water, which leads to an increase in surface area by changing the fiber structure.

Surprisingly, it has been found that a texture component containing an activated plant fiber is particularly well suited for fine-tuning the texture and rheological properties of the sauce or soup.

Preferably, the activated plant fiber is an activated fruit fiber. Particularly advantageously, the activated fruit fiber is an activated citrus fiber or an activated apple fiber.

### The Activated Pectin-Containing Apple Fiber

In a preferred embodiment, an activated pectin-containing apple fiber is used as texturizing agent for the fine texture component b. By using acidic disintegration as a process step during manufacturing, the fiber structure can be disintegrated and this structure maintained accordingly by subsequent alcoholic washing steps and gentle drying.

In the acidic extraction step, the pectin content of the activated pectin-containing apple fiber has been substantially reduced so that this apple fiber contains less than 10 wt %, preferably less than 8 wt % and particularly preferably less than 6 wt % of water-soluble pectin. The content of water-soluble pectin in this apple fiber can be, for instance, 2 wt %, 3 wt %, 4 wt %, 5 wt %, 6 wt %, 7 wt %, 8 wt % or 9 wt %.

This residual water-soluble pectin is a high methoxyl pectin. According to the invention, a high methoxyl pectin is a pectin which has a degree of esterification of at least 50%. The degree of esterification is the percentage of carboxylic groups in the galacturonic acid chains of the pectin which are present in esterified form, e. g. as methyl esters. The degree of esterification can be determined with the method according to JECFA (Monograph 19-2016, Joint FAO/WHO Expert Committee on Food Additives).

In an advantageous embodiment, the activated pectin-containing apple fiber has a firmness of more than 50 g, preferably more than 75 g and particularly preferably more than 100 g. For this purpose, the activated apple fiber is suspended in water as a 6 wt % solution.

The activated pectin-containing apple fiber advantageously has a water binding capacity of more than 20 g/g, preferably more than 22 g/g, particularly preferably more than 24 g/g and especially preferably more than 27.0 g/g. Such an advantageously high water binding capacity leads to a high viscosity and consequently also to a lower fiber consumption with a creamy texture.

In one embodiment, the activated pectin-containing apple fiber has a yield point II (rotation) of more than 0.1 Pa, advantageously more than 0.5 Pa and particularly advantageously more than 1.0 Pa in a 2.5 wt % suspension. In case of a 2.5 wt % dispersion, the activated pectin-containing apple fiber correspondingly has a yield point I (rotation) of more than 5.0 Pa, advantageously more than 6.0 Pa and particularly advantageously more than 7.0 Pa.

According to another embodiment, the activated pectin-containing apple fiber has a yield point II (cross-over) of more than 0.1 Pa, advantageously more than 0.5 Pa and particularly advantageously more than 1.0 Pa in a 2.5 wt % suspension. In a 2.5 wt % dispersion, the activated pectin-containing apple fiber has a yield point I (cross-over) of more than 5.0 Pa, advantageously of more than 6.0 Pa and particularly advantageously more than 7.0 Pa.

In one embodiment, the activated pectin-containing apple fiber has a dynamic Weissenberg number in a 2.5 wt % fiber suspension of more than 4.0, advantageously more than 5.0 and particularly advantageously more than 6.0. After shearing activation, the activated pectin-containing apple fiber accordingly has a dynamic Weissenberg number in a 2.5 wt % fiber dispersion of more than 6.5, advantageously more than 7.5 and particularly advantageously more than 8.5.

To determine the yield point I (rotation), yield point I (cross over) and dynamic Weissenberg number of a 2.5 wt % dispersion, the apple fiber is dispersed in demineralized water as a 2.5 wt % solution using the method disclosed in the examples.

To determine the yield point II (rotation), yield point II (cross over) and dynamic Weissenberg number of a 2.5 wt % suspension, the apple fiber is suspended in demineralized water as a 2.5 wt % solution using the method disclosed in the examples.

Preferably, the activated pectin-containing apple fiber has a viscosity of more than 100 mPas, preferably more than 200 mPas and particularly preferably more than 350 mPas, wherein the activated pectin-containing apple fiber is dispersed in water as a 2.5 wt % solution and the viscosity is measured with a shear rate of 50 s⁻¹ at 20° C.

For determining viscosity, the activated pectin-containing apple fiber is dispersed in demineralized water with the method disclosed in the examples as a 2.5 wt % solution, and viscosity is determined at 20° C. and four shearing sections (first and third section=constant profile; second and fourth section=linear ramp; each measurement at a shearing speed of 50 s⁻¹) (rheometer; Physica MCR 101, measuring bob CC25 [corresponding to Z3 DIN], Anton Paar company, Graz, Austria). The advantage of an activated pectin-containing apple fiber with such a high viscosity is that a lower amount of fiber is necessary for thickening the final product. In addition, the fiber thus creates a creamy texture.

According to one embodiment, the activated pectin-containing apple fiber has a moisture of less than 15 wt %, preferably less than 8 wt % and particularly preferably less than 6 wt %.

It is also preferable for the activated pectin-containing apple fiber to have, in a 1.0 wt % aqueous suspension, a pH value of 3.5 to 5.0 and preferably 4.0 to 4.6.

The activated pectin-containing apple fiber advantageously has a particle size in which at least 90 wt % of the particles are smaller than 400 μm, preferably smaller than 350 μm and particularly preferably smaller than 300 μm.

In one advantageous embodiment, the activated pectin-containing apple fiber has a lightness value of L*>60, preferably L*>61 and particularly preferably L*>62. At such a lightness value, the apple fiber exhibits a slight brown coloration, which makes it particularly suitable for dark sauces or soups and represents added value here. In this case, the use of the apple fiber in the base component and/or the fine texture component can also be used to specifically adjust the coloration and adapt it to the type of sauce or soup (such as in a saffron-salmon sauce).

Advantageously, the activated pectin-containing apple fiber has a dietary fiber content of 80 to 95 wt %.

The activated pectin-containing apple fiber used according to the invention is preferably present in powder form. The advantage is that in this manner, there is a formulation with low weight and long shelf life which is also easy to employ in process technology. This formulation is only made possible by the activated pectin-containing apple fiber used according to the invention which, other than modified starches, does not tend to lump formation when it is dissolved in liquids.

### Production of the Activated Pectin-Containing Apple Fiber

The activated pectin-containing apple fiber is obtainable by a method comprising the following steps:
(a) providing a raw material which contains the cell wall material of an apple;
(b) disintegrating the raw material by incubation of an aqueous suspension of the raw material at an acidic pH value;
(c) one- or multi-stage separation of coarse particles from the disintegrated material from step (b) in aqueous suspension;
(d) separating the material freed from coarse particles obtained in step (c) from the aqueous suspension;
(e) washing of the material separated in step (d) with an aqueous solution;
(f) separating the washed material from step (e) from the aqueous solution;
(g) washing the separated material from step (f) at least twice with an organic solvent and subsequently separating the washed material from the organic solvent;
(h) optionally additionally removing the organic solvent by contacting the washed material respectively from step (g) with water vapor;
(i) drying the material from step (g) or (h), comprising vacuum drying to obtain the activated pectin-containing apple fiber.

The activated pectin-containing apple fiber can be obtained from all cultivated apples (malus domesticus) known to the person skilled in the art. As starting material, advantageously processing residues of apples can be employed. The starting material may be apple peel, apple core, apple seeds, fruit flesh or a combination thereof. Preferably, apple pomace is used as the raw material, i. e. the press residues of apples, which typically also contain the above-mentioned components in addition to the peels.

The manufacturing process according to the invention results in apple fibers with a large internal surface area, which also increases the water binding capacity and is associated with good viscosity formation.

These fibers represent activated fibers that have sufficient firmness in aqueous suspension so that no additional shear forces are required in the application to obtain the optimum rheological properties such as viscosity or texturing on the user side. The activated pectin-containing apple fiber is referred to synonymously as pectin-containing apple fiber in the context of the application.

As the inventors have found, the apple fibers produced by the process of the invention have good rheological properties. The fibers according to the invention can be easily rehydrated and the advantageous rheological properties are retained even after rehydration.

The production method according to the invention results in apple fibers which are to a large degree free of smell and taste and consequently advantageous for use in the food area. The intrinsic flavor of the other ingredients is not masked and can therefore develop in an optimum manner.

The apple fibers according to the invention are obtained from apples, forming natural components with well-known positive characteristics.

The acidic disintegration in step (b) of the method is used to remove pectin by converting the protopectin into soluble pectin and at the same time activating the fiber by enlargement of the interior surface. Furthermore, the raw material is thermally comminuted by the disintegration. Due to acidic incubation in the aqueous environment, with the application of heat, it disintegrates into apple fibers. In this way, thermal comminution is achieved; mechanical comminution is therefore not necessary within the framework of this production method. This is a substantial advantage over conventional fiber production methods which, in contrast, require a shearing step (for instance [high] pressure homogenization) in order to obtain a fiber with sufficient rheological properties.

By using acidic disintegration as a process step during manufacturing, the fiber structure can be disintegrated and this structure maintained accordingly by subsequent alcoholic washing steps and gentle drying.

Due to the acidic extraction step, the activated pectin-containing apple fiber has a pectin content of less than 10 wt %, preferably less than 8 wt % and particularly preferably less than 6 wt % of water-soluble pectin. The activated pectin-containing apple fiber advantageously has a content of water-soluble pectin of between 2 wt % and 8 wt % and particularly preferably of between 2 and 6 wt %. The content of water-soluble pectin in this apple fiber can be, for instance, 2 wt %, 3 wt %, 4 wt %, 5 wt %, 6 wt %, 7 wt %, 8 wt %, 9 wt % or 9.5 wt %.

During the disintegration according to step (b), the raw material is an aqueous suspension. A suspension according to the invention is a heterogeneous mixture of a liquid and solid bodies (raw material particles) finely distributed therein. Since the suspension tends to sedimentation and separation of phases, the particles are suitably kept in suspension by shaking or stirring. That is, there is no dispersion, which would mean that the particles are mechanically comminuted (shearing) so as to be finely dispersed.

To achieve an acidic pH value in step (b), the person skilled in the art may employ all acids or acidic buffering solutions that are known to him. For instance, an organic acid, such as citric acid, can be used.

Alternatively or in combination, a mineral acid may be used. Some examples are sulfuric acid, hydrochloric acid, nitric acid or sulfurous acid. Preferably, sulfuric acid is employed.

In acidic disintegration according to step (b) of the method, the pH value of the suspension is between pH=0.5 and pH=4.0, preferably between pH=1.0 and pH=3.5 and particularly preferably between pH=1.5 and pH=3.0.

According to the invention, the liquid for producing the aqueous suspension consists of more than 50 vol %, preferably more than 60, 70, 80 or even 90 vol %, of water. In a preferred embodiment, the liquid contains no organic solvent and in particular no alcohol. Thus, the process is a water-based acidic extraction.

In one embodiment, the production method, and in particular the acidic disintegration in step (b), do not involve enzymatic treatment of the raw material by addition of an enzyme, in particular no amylase treatment.

In the acidic disintegration in step (b), the incubation takes place at a temperature between 60° C. and 95° C., preferably between 70° C. and 90° C., and particularly preferably between 75° C. and 85° C.

The incubation in step (b) takes place over 60 min to 10 hours, and preferably between 2 and 6 hours.

In acidic disintegration according to step (b), the aqueous suspension suitably has a dry mass of between 0.5 wt % and 5 wt %, preferably of between 1 wt % and 4 wt %, and particularly preferably of between 1.5 wt % and 3 wt %.

During acidic disintegration in step (b), the aqueous suspension is stirred or shaken. This is preferably done continuously to keep the particles in suspension.

In step (c) of the method, the disintegrated material is separated from coarse particles. This separation takes place in one or more stages.

In one- or multi-stage separation according to step (c), it is advantageous to separate off particles with a size of more than 1000 μm, preferably more than 500 μm. In this manner, both coarse particles of the raw material and insufficiently disintegrated material are removed.

Advantageously, the disintegrated material is subjected to multi-stage separation according to step (c). Preferably, increasingly finer particles are separated stepwise from the aqueous suspension. This means that, for example, in case of two-stage separation, both stages separate larger particles from the solution, with the second stage separating off finer particles than the first stage. Thus, the particles forming the material become finer with each separation stage.

In step (c), a two-stage separation is particularly advantageous wherein particles with a size of more than 1000 μm are separated off in the first stage and particles with a size of more than 500 μm in the second stage. The separation in both stages advantageously takes place by means of a sieve drum, a straining machine or another kind of wet sieving.

After acidic disintegration in step (b), removal of coarse particles in step (c) and separation of the disintegrated material from the aqueous suspension in step (d), the separated material is washed with an aqueous solution in step (e). In this step, remaining water-soluble substances, such as e. g. sugars, can be removed. Especially the removal of sugar in this step contributes to lesser adhesion of the apple fiber, which makes it easier to process and to use.

Within the context of this invention, “aqueous solution” is intended to indicate the aqueous liquid employed for washing in step (e). The mixture of this aqueous solution and the disintegrated material is called “washing mixture”.

Advantageously, washing according to step (e) is performed with water as an aqueous solution. The use of deionised water is particularly preferred.

In one embodiment, the aqueous solution consists of more than 50 vol %, preferably more than 60, 70, 80 or even 90 vol % of water. In a preferred embodiment, the aqueous solution contains no organic solvent and in particular no alcohol. Thus, washing is water-based and does not lead to an exchange of water and alcohol as is the case in fiber washing with a mixture of alcohol and water, wherein the mixture has more than 50 vol % of alcohol, typically more than 70 vol % of alcohol.

Alternatively, a saline solution with an ionic strength of I<0.2 mol/l can be used as the aqueous solution.

Washing according to step (e) advantageously takes place at a temperature between 30° C. and 90° C., preferably between 40° C. and 80° C. and particularly preferably between 50° C. and 70° C.

Contacting with the aqueous solution in step (e) takes place between 10 min to 2 hours, preferably between 30 min to one hour.

During washing according to step (e), the dry mass in the washing mixture amounts to between 0.1 wt % and 5 wt %, preferably between 0.5 wt % and 3 wt % and particularly preferably between 1 wt % and 2 wt %.

Advantageously, washing according to step (e) is performed with mechanical movement of the washing mixture. This is expediently done by stirring or shaking.

Optionally, also during washing in step (e), particles can be separated which have a size of more than 500 μm, more preferably more than 400 μm and most preferably 350 μm. Separation advantageously takes place by means of a strainer or a belt press. In this manner, both coarse-particles of the raw material and insufficiently disintegrated material are removed.

After washing with the aqueous solution in step (e), the washed material is separated from the aqueous solution according to step (f). This separation advantageously takes place by means of a decanter or a separator.

In step (g), an additional washing step takes place; this time, however, with an organic solvent. Washing with organic solvent is done at least twice.

The organic solvent can also be a mixture of the organic solvent and water, wherein this mixture then contains more than 50 vol % and preferably more than 70 vol % of organic solvent.

The organic solvent is advantageously an alcohol which can be selected from the group consisting of methanol, ethanol and isopropanol.

The washing step in step (g) takes place at a temperature between 40° C. and 75° C., preferably between 50° C. and 70° C. and particularly preferably between 60° C. and 65° C.

Contacting with the organic solvent in step (g) takes place between 60 min to 10 hours, preferably between 2 hours to 8 hours.

Each step of washing with the organic solvent comprises contacting the material with the organic solvent for a specific duration of time, followed by separation of the material from the organic solvent. For this separation, preferably a decanter or a press is used.

During washing with the organic solvent in step (g), the dry mass in the washing solution amounts to between 0.5 wt % and 15 wt %, preferably between 1.0 wt % and 10 wt % and particularly preferably between 1.5 wt % and 5.0 wt %.

Washing with organic solvent according to step (g) is preferably performed with mechanical movement of the washing mixture. This is preferably done in a tank with a stirring unit.

For washing with the organic solvent in step (g), advantageously a device for homogenization of the suspension is used. This device is preferably a toothed ring disperser.

According to an advantageous embodiment, washing with the organic solvent in step (g) takes place in a counterflow procedure.

In one embodiment, partial neutralization by addition of Na or K salts, NaOH or KOH, takes place during washing in step (g) with the organic solvent.

During washing with the organic solvent in step (g), decoloring of the material can also be performed. This decoloring may take place by the addition of one or more oxidants. For instance, the oxidants could be chlorine dioxide and hydrogen peroxide, which may be used by themselves or in combination.

In an advantageous embodiment, during the at least two-fold washing with an organic solvent in step (g), the concentration of the organic solvent in the solution increases with each washing step. By this incremental increase in organic solvent, the portion of water in the fiber material is reduced in a controlled manner such that the rheological properties of the fibers are maintained during the subsequent steps of solvent removal and drying and the activated fiber structure does not collapse.

Preferably, the final concentration of the organic solvent amounts to between 60 and 70 vol % in the first washing step, between 70 and 85 vol % in the second washing step, and in an optional third washing step, between 80 and 90 vol %.

In the optional step (h), the solvent portion can additionally be reduced by contacting the material with water vapor. This is preferably done by means of a stripper in which the material is contacted in countercurrent with water vapor as the stripping gas.

In step (i), the washed material from step (g) or the stripped material from step (h) are dried, wherein the drying process comprises vacuum drying and preferably consists of vacuum drying. In vacuum drying, the washed material as drying material is subjected to a vacuum, which lowers the boiling point, thus leading to evaporation of the water even at low temperatures. The evaporation heat, which is continuously lost by the drying material, is suitably restored from outside up to constant temperature. The effect of vacuum drying is that it lowers the equilibrium vapor pressure, promoting capillary transport. This has in particular been proven advantageous for the present apple fiber material since in this manner the activated open fiber structures and the resulting rheological properties are maintained. Preferably, vacuum drying takes place at an absolute negative pressure of less than 400 mbar, preferably less than 300 mbar, further preferably less than 250 mbar and particularly preferably less than 200 mbar.

Drying under vacuum in step (i) advantageously takes place at a shell temperature of between 40° C. and 100° C., preferably between 50° C. and 90° C. and particularly preferably between 60° C. and 80° C. After drying, the product is advantageously cooled to ambient temperature.

In an advantageous embodiment, the method additionally comprises a comminution, milling or sieving step after drying in step (i). This step is advantageously performed such that as a result, 90% of the particles have a size of less than 400 μm, preferably less than 350 μm and particularly preferably less than 300 μm. At this particle size, the fiber is well dispersible and has optimum swelling properties.

The activated pectin-containing apple fiber used according to the invention, as well as a method to the production thereof, are disclosed in the application DE 10 2020 122 520.2.

### The Activated Pectin-Containing Citrus Fiber

In a preferred embodiment, an activated pectin-containing citrus fiber is used as texturizing agent for the fine texture component b. By using acidic disintegration as a process step during manufacturing, the fiber structure can be disintegrated and this structure maintained accordingly by subsequent alcoholic washing steps and gentle drying.

In the acidic extraction step, the pectin content of the activated pectin-containing citrus fiber has been substantially reduced so that this citrus fiber contains less than 10 wt %, preferably less than 8 wt % and particularly preferably less than 6 wt % of water-soluble pectin. The content of water-soluble pectin in this citrus fiber can be, for instance, 2 wt %, 3 wt %, 4 wt %, 5 wt %, 6 wt %, 7 wt %, 8 wt % or 9 wt %.

This residual water-soluble pectin is a high methylester pectin. According to the invention, a high methoxyl pectin is a pectin which has a degree of esterification of at least 50%. The degree of esterification is the percentage of carboxylic groups in the galacturonic acid chains of the pectin which are present in esterified form, e. g. as methyl esters. The degree of esterification can be determined with the method according to JECFA (Monograph 19-2016, Joint FAO/WHO Expert Committee on Food Additives).

In an advantageous embodiment, the activated pectin-containing citrus fiber has, in a 4 wt % aqueous suspension, a firmness of at least 150 g, particularly advantageously of at least 220 g.

The activated pectin-containing citrus fiber advantageously has a water binding capacity of more than 22 g/g. Such an advantageously high-water binding capacity leads to a high viscosity and consequently also to a lower fiber consumption with a creamy texture.

In one embodiment, the activated pectin-containing citrus fiber has a yield point II (rotation) of more than 1.5 Pa and advantageously of more than 2.0 Pa in a 2.5 wt % fiber suspension. In case of a fiber dispersion, the activated pectin-containing citrus fiber correspondingly has a yield point I (rotation) of more than 5.5 Pa and advantageously of more than 6.0 Pa.

According to another embodiment, the activated pectin-containing citrus fiber has a yield point II (cross-over) of more than 1.2 Pa and advantageously more than 1.5 Pa in a 2.5 wt % fiber suspension. In case of a fiber dispersion, the activated pectin-containing citrus fiber has a yield point I (cross-over) of more than 6.0 Pa and advantageously of more than 6.5 Pa.

In one embodiment, the activated pectin-containing citrus fiber has a dynamic Weissenberg number in the fiber suspension of more than 7.0, advantageously more than 7.5 and particularly advantageously more than 8.0. After shearing activation, the activated pectin-containing citrus fiber accordingly has a dynamic Weissenberg number in the fiber dispersion of more than 6.0, advantageously more than 6.5 and particularly advantageously more than 7.0.

To determine the yield point I (rotation), yield point I (cross over) and dynamic Weissenberg number of a 2.5 wt % dispersion, the citrus fiber is dispersed in demineralized water as a 2.5 wt % solution using the method disclosed in the examples.

To determine the yield point II (rotation), yield point II (cross over) and dynamic Weissenberg number of a 2.5 wt % suspension, the citrus fiber is suspended in demineralized water as a 2.5 wt % solution using the method disclosed in the examples.

Preferably, the activated pectin-containing citrus fiber has a viscosity of at least 650 mPas, wherein the activated pectin-containing citrus fiber is dispersed in water as a 2.5 wt % solution and the viscosity is measured with a shear rate of 50 s⁻¹ at 20° C.

For determining viscosity, the activated pectin-containing citrus fiber is dispersed in demineralized water with the method disclosed in the examples as a 2.5 wt % solution, and viscosity is determined at 20° C. and four shearing sections (first and third section=constant profile; second and fourth section=linear ramp; each measurement at a shearing speed of 50 s⁻¹) (rheometer; Physica MCR series, measuring bob CC25 [corresponding to Z3 DIN], Anton Paar company, Graz, Austria). The advantage of an activated pectin-containing citrus fiber with such a high viscosity is that a lower amount of fiber is necessary for thickening the final product. In addition, the fiber thus creates a creamy texture.

According to one embodiment, the activated pectin-containing citrus fiber has a moisture of less than 15 wt %, preferably less than 10 wt % and particularly preferably less than 8 wt %.

It is also preferable for the activated pectin-containing citrus fiber to have, in a 1.0 wt % aqueous solution, a pH value of 3.1 to 4.75 and preferably 3.4 to 4.2.

The activated pectin-containing citrus fiber advantageously has a particle size in which at least 90 wt % of the particles are smaller than 250 μm, preferably smaller than 200 μm and particularly preferably smaller than 150 μm.

In one advantageous embodiment, the activated pectin-containing citrus fiber has a lightness value of L*>90, preferably L*>91 and particularly preferably L*>92.

Advantageously, the activated pectin-containing citrus fiber has a dietary fiber content of 80 to 95 wt %.

The activated pectin-containing citrus fiber used according to the invention is preferably present in powder form. The advantage is that in this manner, there is a formulation with low weight and long shelf life which is also easy to employ in process technology. This formulation is only made possible by the activated pectin-containing citrus fiber used according to the invention which, other than modified starches, does not tend to lump formation when it is dissolved in liquids.

### Production of the Activated Pectin-Containing Citrus Fiber

The activated pectin-containing citrus fiber is obtainable by a method comprising the following steps:
(a) providing a raw material which contains the cell wall material of an edible citrus fruit;
(b) disintegrating the raw material by incubation of an aqueous suspension of the raw material at an acidic pH value;
(c) one- or multi-stage separation of the disintegrated material in step (b) from the aqueous suspension;
(d) washing of the material separated in step (c) with an aqueous solution and separation of coarse or non-disintegrated particles;
(e) separating the washed material in step (d) from the aqueous solution;
(f) washing the separated material from step (e) at least twice with an organic solvent and subsequently separating the washed material respectively from the organic solvent;
(g) optionally additionally removing the organic solvent by contacting the washed material from step (f) with water vapor;
(h) drying the material from step (f) or (g), comprising vacuum drying to obtain the activated pectin-containing citrus fiber.

As raw material, citrus fruits, and preferably processing residues of citrus fruits, can be employed. The raw material to be used in the method described herein may be citrus peel (albedo and/or flavedo), citrus vesicles, segment membranes or a combination thereof. Preferably, citrus pulp is used as the raw material, i. e. the press residues of citrus fruits, which typically also contain the fruit flesh in addition to the peels.

These fibers are activated fibers with sufficient firmness in an aqueous suspension so that no additional shear forces are required during application for the user to obtain optimum rheological properties such as viscosity or texturing. Within the framework of the application, the activated pectin-containing citrus fiber is synonymously also called “pectin-containing citrus fiber”.

The inventors have found the citrus fibers produced with this method to have good rheological properties. The fibers according to the invention can be easily rehydrated, and the advantageous rheological properties are maintained even after rehydration.

The production method described above results in citrus fibers which are to a large degree free of smell and taste and consequently advantageous for use in the food area. The intrinsic flavor of the other ingredients is not masked and can therefore develop in an optimum manner.

The citrus fibers to be used according to the invention are obtained from citrus fruits, forming natural components with well-known positive characteristics.

The acidic disintegration in step (b) of the method is used to remove pectin by converting the protopectin into soluble pectin and at the same time activating the fiber by enlargement of the interior surface. Furthermore, the raw material is thermally comminuted by the disintegration. Due to acidic incubation in the aqueous environment, with the application of heat, it disintegrates into citrus fibers. In this way, thermal comminution is achieved; mechanical comminution is not necessary within the framework of this production method. This is a substantial advantage over conventional fiber production methods which, in contrast, require a shearing step (for instance [high] pressure homogenization) in order to obtain a fiber with sufficient rheological properties.

By using acidic disintegration as a process step during manufacturing, the fiber structure can be disintegrated, and this structure maintained accordingly by subsequent alcoholic washing steps and gentle drying.

Due to the acidic extraction step, the activated citrus fiber has a pectin content of less than 10 wt %, preferably less than 8 wt % and particularly preferably less than 6 wt % of water-soluble pectin. The activated pectin-containing citrus fiber advantageously has a content of water-soluble pectin of between 2 wt % and 8 wt % and particularly preferably of between 2 and 6 wt %. The content of water-soluble pectin in this citrus fiber can be, for instance, 2 wt %, 3 wt %, 4 wt %, 5 wt %, 6 wt %, 7 wt %, 8 wt %, 9 wt % or 9.5 wt %.

During the disintegration according to step (b), the raw material is an aqueous suspension. A suspension according to the invention is a heterogeneous mixture of a liquid and solids (raw material particles) finely distributed therein. Since the suspension tends to sedimentation and separation of phases, the particles are suitably kept in suspension by shaking or stirring. That is, there is no dispersion, which would mean that the particles are mechanically comminuted (shearing) so as to be finely dispersed.

To achieve an acidic pH value in step (b), the person skilled in the art may employ all acids or acidic buffering solutions that are known to him. For instance, an organic acid, such as citric acid, can be used.

Alternatively, or in combination, a mineral acid may be used. Some examples are sulfuric acid, hydrochloric acid, nitric acid or sulfurous acid. Preferably, nitric acid is employed.

In acidic disintegration according to step (b) of the method, the pH value of the suspension is between pH=0.5 and pH=4.0, preferably between pH=1.0 and pH=3.5 and particularly preferably between pH=1.5 and pH=3.0.

In the acidic disintegration in step (b), the incubation takes place at a temperature between 60° C. and 95° C., preferably between 70° C. and 90° C., and particularly preferably between 75° C. and 85° C.

According to the invention, the liquid for producing the aqueous suspension consists of more than 50 vol %, preferably more than 60, 70, 80 or even 90 vol %, of water. In a preferred embodiment, the liquid contains no organic solvent and in particular no alcohol. Thus, the process is a water-based acidic extraction.

In one embodiment, the production method, and in particular the acidic disintegration in step (b), do not involve enzymatic treatment of the raw material by addition of an enzyme, in particular no amylase treatment.

The incubation in step (b) takes place over 60 min to 8 hours, and preferably over 2 to 6 hours.

In acidic disintegration according to step (b), the aqueous suspension suitably has a dry mass of between 0.5 wt % 5 wt % preferably of between 1 wt % and 4 wt %, and particularly preferably of between 1.5 wt % and 3 wt %.

During acidic disintegration in step (b), the aqueous suspension is stirred or shaken. This is preferably done continuously to keep the particles in suspension.

In step (c) of the method, the disintegrated material is separated from the aqueous solution and thus recovered. This separation takes place in one or more steps.

Advantageously, the disintegrated material is subjected to multi-step separation according to step (c). Preferably, increasingly finer particles are separated stepwise from the aqueous suspension. This means that, for example, in case of two-step separation, both steps separate larger particles from the solution, with the second step separating off finer particles than the first step so as to achieve as complete a separation of the particles from the aqueous suspension as possible. Preferably, the first separation is done by means of decanters and the second one by means of separators. Thus, the particles forming the material become finer with each separation step.

After acidic disintegration in step (b) and separation of the disintegrated material in step (c), the separated material is washed with an aqueous solution in step (d). In this step, remaining water-soluble substances, such as e. g. sugars, can be removed. Especially the removal of sugar in this step contributes to lesser adhesion of the citrus fiber, which makes it easier to process and to use.

Within the context of this invention, “aqueous solution” is intended to indicate the aqueous liquid employed for washing in step (d). The mixture of this aqueous solution and the disintegrated material is called “washing mixture”.

Advantageously, washing according to step (d) is performed with water as an aqueous solution. The use of deionised water is particularly preferred.

In one embodiment, the aqueous solution consists of more than 50 vol %, preferably more than 60, 70, 80 or even 90 vol % of water. In a preferred embodiment, the aqueous solution contains no organic solvent and in particular no alcohol. Thus, washing is water-based and does not lead to an exchange of water and alcohol as is the case in fiber washing with a mixture of alcohol and water, wherein the mixture has more than 50 vol % of alcohol, typically more than 70 vol % of alcohol.

Alternatively, a saline solution with an ionic strength of I<0.2 mol/l can be used as the aqueous solution.

Washing according to step (d) advantageously takes place at a temperature between 30° C. and 90° C., preferably between 40° C. and 80° C. and particularly preferably between 50° C. and 70° C.

Contacting with the aqueous solution takes place between 10 min to 2 hours, preferably between 30 min to one hour.

During washing according to step (d), the dry mass in the washing mixture amounts to between 0.1 wt % and 5 wt %, preferably between 0.5 wt % and 3 wt % and particularly preferably between 1 wt % and 2 wt %.

Advantageously, washing according to step (d) is performed with mechanical movement of the washing mixture. This is expediently done by stirring or shaking.

During washing according to step (d), a separation of larger or non-disintegrated particles takes place. Preferably, particles are separated which have a size of more than 500 μm, more preferably more than 400 μm and most preferably 350 μm.

Separation is done advantageously by wet sieving. For this purpose, a strainer or a belt press may be used. In this manner, both coarse-particle impurities within the raw material and insufficiently disintegrated material are removed.

After washing with the aqueous solution, the washed material is separated from the aqueous solution according to step (e). This separation advantageously takes place by means of a decanter or a separator.

In step (f), an additional washing step takes place; this time, however, with an organic solvent. Washing with organic solvent is done at least twice.

The organic solvent can also be a mixture of the organic solvent and water, wherein this mixture then contains more than 50 vol % and preferably more than 70 vol % of organic solvent.

The organic solvent in step f) is advantageously an alcohol which can be selected from the group consisting of methanol, ethanol and isopropanol.

The washing step takes place at a temperature between 40° C. and 75° C., preferably between 50° C. and 70° C. and particularly preferably between 60° C. and 65° C.

Contacting with the organic solvent in step (f) takes place between 60 min to 10 hours, preferably between 2 hours to 8 hours.

Each step of washing with the organic solvent comprises contacting the material with the organic solvent for a specific duration of time, followed by separation of the material from the organic solvent. For this separation, preferably a decanter or a press is used.

During washing with the organic solvent in step (f), the dry mass in the washing solution amounts to between 0.5 wt % and 15 wt %, preferably between 1.0 wt % and 10 wt % and particularly preferably between 1.5 wt % and 5.0 wt %.

Washing with organic solvent according to step (f) is preferably performed with mechanical movement of the washing mixture. This is preferably done in a tank with a stirring unit.

For washing with the organic solvent in step (f), advantageously a device for homogenization of the suspension is used. This device is preferably a toothed ring disperser.

According to an advantageous embodiment, washing with the organic solvent in step (f) takes place in a counterflow procedure.

In one embodiment, partial neutralisation by addition of Na or K salts, NaOH or KOH, takes place during washing in step (f) with the organic solvent.

During washing with the organic solvent in step (f), decolouring of the material can also be performed. This decolouring may take place by the addition of one or more oxidants. For instance, the oxidants could be chlorine dioxide and hydrogen peroxide, which may be used by themselves or in combination.

In an advantageous embodiment, during the at least two-fold washing with an organic solvent in step (f), the concentration of the organic solvent in the solution increases with each washing step. By this incremental increase in organic solvent, the portion of water in the fiber material is reduced in a controlled manner such that the rheological properties of the fibers are maintained during the subsequent steps of solvent removal and drying, and the activated fiber structure does not collapse.

Preferably, the final concentration of the organic solvent amounts to between 60 and 70 vol % in the first washing step, between 70 and 85 vol % in the second washing step, and in an optional third washing step, between 80 and 90 vol %.

In the optional step (g), the solvent content can additionally be reduced by contacting the material with water vapor. This is preferably done by means of a stripper in which the material is contacted with water vapor as the stripping gas in countercurrent.

In step (h), the washed material from step (f) or the stripped material from step (g) are dried, wherein the drying process comprises vacuum drying and preferably consists of vacuum drying. During vacuum drying, the washed material as drying material is subjected to a vacuum, which lowers the boiling point, thus leading to evaporation of the water even at low temperatures. The evaporation heat, which is continuously lost by the drying material, is suitably restored from outside up to constant temperature. The effect of vacuum drying is that it lowers the equilibrium vapor pressure, promoting capillary transport. This has in particular been proven advantageous for the present citrus fiber material since in this manner the activated open fiber structures and the resulting rheological properties are maintained. Preferably, vacuum drying takes place at a negative pressure of less than 400 mbar, preferably less than 300 mbar, further preferably less than 250 mbar and particularly preferably less than 200 mbar.

Drying under vacuum in step (h) advantageously takes place at a shell temperature of between 40° C. and 100° C., preferably between 50° C. and 90° C. and particularly preferably between 60° C. and 80° C. After drying, the product is advantageously cooled to ambient temperature.

In an advantageous embodiment, the method additionally comprises a comminution, milling or sieving step after drying in step (h). This step is advantageously performed such that as a result, 90% of the particles have a size of less than 250 μm, preferably less than 200 μm and in particular less than 150 μm. At this particle size, the fiber is well dispersible and has optimum swelling properties.

The activated pectin-containing citrus fiber used according to the invention, as well as a method to the production thereof, are disclosed in the application DE 10 2020 122 518.0.

According to a preferred embodiment of the multi-component system according to the invention, the fine texture component b. is present in paste form. If the fine texture component is present in paste form, the texture can be adjusted particularly quickly and uniformly.

It is particularly advantageous if the fine texture component b. influences not only the rheological properties but also the flavor properties of the sauce or soup. According to a preferred embodiment of the invention, the fine texture component b. thus contains a flavoring agent. According to a further preferred embodiment, the fine texture component b. comprises at least two flavoring agents or at least three flavoring agents or at least four flavoring agents or at least five flavoring agents. By using one or more flavoring substances in the fine texture component b., the taste and/or odor of the sauce or soup can be optimally adjusted and flexibly varied.

The term “flavoring agent” within the meaning of the invention refers to a chemical substance or a chemical mixture of substances that can evoke a specific odor and/or taste in humans. This is essentially achieved by the binding of specific taste receptors in humans by the flavoring substance.

Particularly preferably, the fine texture component b. contains a natural flavoring agent. According to a further preferred embodiment, the fine texture component b. contains at least two natural flavoring substances or at least three natural flavoring substances or at least four natural flavoring substances or at least five natural flavoring substances. Natural flavoring agents are particularly good at achieving the desired flavor. In addition, natural flavoring substances are particularly well accepted by consumers.

In this context, the term “natural flavoring substance” within the meaning of the invention refers to a flavoring substance obtained from natural sources, for example and preferably from plants, in particular by means of extraction. In contrast to a natural flavoring substance is a synthetic flavoring substance which is produced in the laboratory by means of synthetic processes.

The flavoring component or the combination of several flavoring components can be used to achieve completely different flavors for the sauce or soup. For example, the fine texture component b. can, for example, have duck, goose, pork, game, lamb, beef, veal, chicken, fish, crustaceans, vegetables, roasted vegetables, truffles, porcini, mushrooms, onions, garlic, orange, lemon, lime, smoke, vinegar, pickles, capers, butter, mustard, curry, saffron, cress, thyme, basil, rosemary, nutmeg, juniper or bay leaf as a flavoring. The fine texture component b. may also have a flavor typical of dishes from certain regions, such as French, Asian, Scandinavian, or African. Further, it is possible that the flavor resembles certain beverages, for example, that the textured component b. has as flavor red wine, white wine, sherry, port wine, whiskey or cognac. Other flavors of the fine texture component b. can be achieved depending on the flavoring agents used.

According to a preferred embodiment, the fine texture component b. is vegan. The term “vegan” in the sense of the invention means that the fine texture component b. does not contain any components of animal origin. In this context, the fine texture component b. can have an animal-like taste, which is perceived by test persons as tasting of chicken, game or fish, and at the same time be vegan. This is achieved by one or more flavoring agents that are vegan in nature but mimic a taste such as chicken, game or fish.

The fine texture component b. may contain different constituents in widely varying ranges. A particularly preferred fine texture component b. of the multicomponent system for preparing a sauce or a soup contains (1) from 0.1 to 30 wt %, preferably from 0.5 to 25 wt %, more preferably from 1 to 15 wt % or particularly preferably from 2 to 10 wt % of activated plant fiber, (2) from 50 to 99 wt %, preferably from 60 to 95 wt %, more preferably from 70 to 92 wt % and particularly preferably from 70 to 92 wt %, of activated plant fiber, preferably from 60 to 95% by weight, more preferably from 70 to 92% by weight and particularly preferably from 78 to 90% by weight of water, (3) the remainder being aromatic substances and other constituents, the percentages by weight being based in each case on the total weight of the fine texture component b.

### Refinement Component

The multi-component system according to the invention optionally contains a refining component c. The refining component enables the sauce or soup to be optimally customized depending on the specific application.

Different ingredients can be selected as refinement components. For example, herbs and spices such as anise, wild garlic, basil, fenugreek, cayenne pepper, chili, cumin, curry, dill, tarragon, fennel, cloves, ginger, chamomile, cardamom, garlic, coriander, cumin, turmeric, horseradish, lemon balm, nutmeg, paprika, parsley, bell pepper, peppermint, allspice, saffron, sage, star anise, thyme, vanilla, juniper berries, cinnamon or lemongrass may be used as a refining component. Furthermore, the refining component may have a vegetable ingredient such as onion, garlic, chives, leeks, garden leeks, shallots or scallions.

In another embodiment, the refining component includes an essential oil such as a lemon oil, orange oil, basil oil, peppermint oil, vanilla oil, thyme oil, bay oil, lemongrass oil, or rosemary oil, or a peel of an oleaginous fruit such as orange peel, lemon peel, or lime peel. The refining component may also include a flavored edible oil such as truffle oil or lemon oil, or an oil extracted from an aromatic oleaginous fruit by pressing such as sesame oil or pumpkin seed oil.

The refining component can also be a fatty food, such as butter, cream, butterfat (ghee).

In one embodiment, the refining component may comprise: Stocks, berries or other fruits or buds and their components, juices, and alcohol-containing liquids such as brandy or wine.

These materials may also already be available from other suppliers as ready-made, directly usable products (so-called “convenience products”), such as seasoning pastes like ginger paste, garlic paste, red wine reduction, mushroom powder, herb pastes like wild garlic, basil, marjoram, or as extract oils, as in the case of: truffle oil, sesame oil or pumpkin seed oil.

It is also possible to use one or more flavoring agents as a refining component, in particular also natural flavoring agents. The above-mentioned refining components can also be combined as required to produce the sauce or soup.

### Multi-Component System

The multi-component system according to the invention contains
a. a base component containing a water binder,
b. a fine texture component, and
c. optionally a refining component.

The components can be used in different proportions to each other in the multi-component system to obtain variable sauces and/or soups with desired flavor and texture properties.

According to a preferred embodiment of the invention, the multi-component system has a proportion of base component a. of from 20 to 95 wt %, preferably from 40 to 90 wt % or particularly preferably from 50 to 80 wt %, based on the combined weight of base component a. and fine texture component b. Accordingly, it is advantageous if the multi-component system has a proportion of fine texture component b. of from 5 to 80 wt %, in particular from 10 to 60 wt % or from 20 to 50 wt %, based on the combined weight of the base component a. and the fine texture component b.

According to one embodiment, the multi-component system according to the invention has a proportion of refining component c., based on the total weight of components a., b. and c., of 0.01 to 20 wt %, preferably of 0.1 to 15 wt % and particularly preferably of 1 to 10 wt %. With such a proportion, the refining component can be used to adjust the flavor of the sauce or soup optimally to individual requirements without influencing the texture or the basic flavor of the sauce or soup too much.

According to a preferred embodiment, the base component a., fine texture component b. and refining component c. components of the multicomponent system have a total plant fiber content of 0.1 to 40 wt %, preferably of 0.5 to 10 wt % or particularly preferably of 1 to 5 wt %, based on the combined weight of the base component a., fine texture component b. and refining component c. components. With such a proportion of plant fibers in the components of the multicomponent system, a sauce or soup with particularly good rheological properties and excellent cooking behavior is obtained.

In a particularly advantageous embodiment of the multicomponent system according to the invention, the base component a. contains a native plant fiber as water binder and the fine texture component b. contains an activated plant fiber. Surprisingly, it has been found that the interaction of the native plant fiber as water binder in the base component a. with the activated plant fiber in the fine texture component b. makes it possible to achieve a particularly creamy texture of the sauce or soup. A sauce or soup made from this preferred multi-component system according to the invention exhibits a particularly pleasant mouthfeel and low roughness. Without wishing to be bound by any particular scientific theory, this surprising effect appears to be due to the reduction in fiber spacing of the native plant fibers by the activated plant fiber.

### Use

In another aspect, the present invention relates to the use of the multicomponent system according to the invention for preparing a sauce or a soup. The multi-component system according to the invention can be used for the production of sauces or soups on an industrial scale. Preferably, the use of the multicomponent system according to the invention relates to the production of sauces or soups in the gastronomic industry, particularly preferably for the fresh production of sauces or soups. In this context, the term “gastronomic industry” basically covers all providers of food to customers for direct consumption, for example restaurants, bars, bistros, hotels, pubs, delivery services, snack bars, canteens and cafeterias. In this context, the term “fresh production” refers to the production of a sauce or soup intended for partial or complete consumption in the 24 hours following production.

What has been said about the multi-component system according to the invention and about the base component a., the fine texture component b. and the refinement component c. of the multi-component system according to the invention applies equally to the use of the multi-component system according to the invention.

### Sauce/Soup

In another aspect, the present invention relates to a sauce comprising the base component a., the fine texture component b. and optionally the refining component c. and water. The sauce according to the invention is characterized by a pleasant taste and excellent textural properties.

In another aspect, the present invention relates to a soup comprising the base component a., the fine texture component b. and optionally the refining component c. and water. The soup according to the invention is characterized by a pleasant taste and excellent flow properties.

The sauce and/or soup according to the invention is obtainable from the multi-component system according to the invention.

According to a preferred embodiment of the invention, the sauce contains 0.1 to 15 wt %, preferably 0.5 to 8 wt %, combined amount of base component a., fine texture component b. and refining component c., based on the total weight of the sauce. The percentage by weight refers here to the combined weight of the three components. For example, if the sauce according to the invention contains 0.8 wt % base component a., 0.5 wt % fine texture component b. and 0.2 wt % refining component c., the sauce contains 1.5 wt % combined proportion of base component a., fine texture component b. and refining component c., based on the total weight of the sauce. A sauce with this proportion of the components of the multicomponent system according to the invention exhibits optimum texture and flow properties.

According to a preferred embodiment of the invention, the soup contains 0.1 to 15 wt %, preferably 0.5 to 8 wt %, combined amount of base component a., fine texture component b. and refining component c., based on the total weight of the soup. The percentage by weight refers here to the combined weight of the three components. For example, if the soup according to the invention contains 0.8 wt % base component a., 0.5 wt % fine texture component b. and 0.2 wt % refining component c., the soup contains 1.5 wt % combined proportion of base component a., fine texture component b. and refining component c., based on the total weight of the soup. A soup with this proportion of the components of the multicomponent system according to the invention exhibits optimum texture and flow properties.

According to an advantageous embodiment, the sauce according to the invention may contain per liter of water from 10 to 150 g, preferably from 20 to 100 g, preferably from 30 to 90 g or particularly preferably from 40 to 80 g, base component a., from 10 to 50 g, preferably from 15 to 45 g, preferably from 20 to 40 g or particularly preferably from 25 to 35 g, fine texture component b., and from 1 to 50 g, preferably from 5 to 40 g, refining component c.

According to an advantageous embodiment, the soup according to the invention may contain per liter of water from 10 to 150 g, preferably from 20 to 100 g, preferably from 30 to 90 g or particularly preferably from 40 to 80 g, base component a., from 10 to 50 g, preferably from 15 to 45 g, preferably from 20 to 40 g or particularly preferably from 25 to 35 g, fine texture component b., and from 1 to 50 g, preferably from 5 to 40 g, refining component c.

According to a further preferred embodiment, the sauce according to the invention has a caloric value of 5 kcal to 500 kcal/100 g (corresponding to 20.92 kJ to 2092 kJ/100 g), preferably of 10 kcal to 400 kcal/100 g (corresponding to 41.84 kJ to 1673.6 kJ/100 g), particularly preferably from 40 kcal to 250 kcal/100 g (corresponding to 167.36 kJ to 1046 kJ/100 g), most preferably 50 kcal to 150 kcal/100 g (corresponding to 209.2 kJ to 627.6 kJ/100 g). A sauce with such a caloric value is perfectly suitable for a healthy and low-calorie diet.

According to a further preferred embodiment, the soup according to the invention has a caloric value of 5 kcal to 500 kcal/100 g (corresponding to 20.92 kJ to 2092 kJ/100 g), preferably of 10 kcal to 400 kcal/100 g (corresponding to 41.84 kJ to 1673.6 kJ/100 g), particularly preferably from 40 kcal to 250 kcal/100 g (corresponding to 167.36 kJ to 1046 kJ/100 g), most preferably 50 kcal to 150 kcal/100 g (corresponding to 209.2 kJ to 627.6 kJ/100 g). A soup with such a caloric value is perfectly suitable for a healthy and low-calorie diet.

According to a preferred embodiment of the invention, the sauce has a salt content of less than 10 g, preferably less than 5 g, per kg of sauce. With such a low salt content, the sauce according to the invention is particularly suitable for a healthy diet with low salt intake. In particular, with such a low salt content, the sauce according to the invention is also particularly suitable for people who have to control and keep their salt content and keep it low due to pre-existing conditions.

According to a preferred embodiment of the invention, the soup has a salt content of less than 10 g, preferably less than 5 g, per kg of soup. With such a low salt content, the soup according to the invention is particularly suitable for a healthy diet with low salt intake. In particular, with such a low salt content, the soup according to the invention is also particularly suitable for people who have to control and keep their salt content low due to pre-existing conditions.

Preferably, the sauce according to the invention is vegan. In this way, even if the sauce has an ostensibly “animal taste”, it can be suitable for consumption by vegans and other groups of people who abstain from certain animal products.

Preferably, the soup according to the invention is vegan. In this way, even if the soup has an ostensibly “animal taste”, it can be suitable for consumption by vegans and other groups of people who abstain from certain animal products.

What has been said for the base component a., the fine texture component b. and the refinement component c. of the multi-component system according to the invention applies equally to the base component a., the fine texture component b. and the refinement component c. of the sauce according to the invention.

What has been said for the base component a., the fine texture component b. and the refinement component c. of the multi-component system according to the invention applies equally to the base component a., the fine texture component b. and the refinement component c. of the soup according to the invention.

### Method

In another aspect, the present invention relates to a method for preparing a sauce and/or soup by using the multicomponent system according to the invention. The method according to the invention goes through the following steps:
(1) Providing a base component a., a fine texture component b. and optionally a refining component c.,
(2) Placing the components provided in step (1) in water and mixing to obtain a mixture,
(3) optionally heating the mixture obtained in step (2).

The steps of the process according to the invention can be carried out in different sequences. In particular, the base component a. can first be introduced into water, the solution or suspension thus obtained can be mixed and optionally already heated, and only subsequently the fine texture component b. and optionally the refining component c. can be added.

Particularly advantageously, the base component a. is first provided, placed in water and mixed to obtain a mixture. This mixture is then preferably heated. Subsequently, the fine texture component b. is provided and introduced into the mixture containing the base component a. and the mixture is mixed again. In this process, the mixture may be heated at the time the fine texture component b. is introduced. Finally, the refining component c. can be provided and introduced into the mixture containing base component a. and fine texture component b. and mixed with these components.

The water used in the process according to the invention may already contain flavor carriers or other components. Thus, a broth or a stock can be used as water.

The ratio of base component a., fine texture component b., refining component c. and the water used to make the sauce or soup can vary over wide ranges. Preferably, for one liter of water, from 10 to 150 g, preferably from 20 to 100 g, preferably from 30 to 90 g or more preferably from 40 to 80 g, base component a., from 10 to 50 g, preferably from 15 to 45 g, preferably from 20 to 40 g or more preferably from 25 to 35 g, fine texture component b., and from 1 to 50 g, preferably from 5 to 40 g, refining component c., are used.

What has been said about the multi-component system according to the invention and about the base component a., the fine texture component b. and the refinement component c. of the multi-component system according to the invention applies equally to the process according to the invention.

### DEFINITIONS

A “citrus fiber” in the sense of the application is a component consisting mainly of fibers, which is isolated from a non-lignified cellular wall of a citrus fruit and consists mainly of cellulose. In a sense, the term “fiber” is a misnomer since macroscopically, the citrus fibers do not appear as fibers but as a powdery product. Other components of the citrus fiber are, among others, hemicellulose and pectin. The citrus fiber can advantageously be obtained from citrus pulp, citrus peel, citrus vesicle, segment membranes or a combination thereof.

An activated apple fiber according to the present invention, as distinguished from an activatable apple fiber (and thus merely partially activated apple fiber), defined by the yield point of the fiber in 2.5% dispersion. An activated apple fiber is thus characterized by a yield point I (rotation) of more than 5.0 Pa or a yield point I (cross-over) of more than 5.0 Pa. An activatable apple fiber is thus characterized by a yield point I (rotation) of between 0.75-3.75 Pa or a yield point I (cross-over) of between 0.75-4.25 Pa.

An activated citrus fiber according to the present invention, as distinguished from an activatable citrus fiber (and thus merely partially activated citrus fiber), defined by the yield point of the fiber in 2.5% dispersion or the viscosity. An activated citrus fiber is thus characterized by a yield point I (rotation) of more than 5.5 Pa, a yield point I (cross-over) of more than 6.0 Pa or a viscosity of more than 650 mPa*s. An activatable citrus fiber is thus characterized by a yield point I (rotation) of between 1.0-4.5 Pa, a yield point I (cross-over) of between 1.0-4.5 Pa or a viscosity of 150 to 600 mPa*s.

At this point, it is explicitly pointed out that features of the solutions described above, in the Claims and/or in the Figures can also be combined, if desired, in order to achieve cumulated implementation of the explained features, effects and advantages.

All features disclosed in the application documents are claimed as essential for the invention provided that they are, individually or in combination, novel over the state of the art.

It is explicitly pointed out that within the framework of the present patent application, indefinite articles and numerals such as “one”, “two” etc. are normally to be understood as indicating a minimum, i. e. “at least one . . . ”, “at least two . . . ” etc., unless it becomes explicitly clear from the context or is obvious or imperative to the person skilled in the art from a technical point of view that only “exactly one . . . ”, “exactly two . . . ” etc. can be intended.

Other advantages, particularities and expedient embodiments of the invention will become clear from the dependent Claims and the following presentation of preferred embodiments by means of the Figures.

The embodiments shown here are only examples of the present invention and are therefore not to be understood as limiting. Alternative embodiments considered by the person skilled in the art are equally comprised by the scope of protection of the invention.

### EXAMPLES OF EMBODIMENT

### 1 Preparation of a Citrus or Apple Fiber According to the Invention

### A. Preparation of an Activatable, Pectin-Containing Citrus Fiber

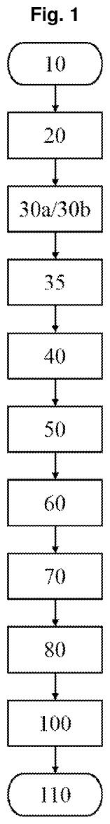

FIG. 1 is a schematic representation of a method of preparing the activatable, pectin-containing citrus fiber in the form of a flowchart. Starting from the citrus pulp 10, the pulp is disintegrated by hydrolytic 20 incubation in an acidic solution at 70° to 80° C. Two separate steps 30a (decanter) and 30b (separator) follow for as complete a separation of all particles from the liquid phase as possible. The separated material is washed with an aqueous solution 35. From the washing mixture thus obtained, coarse or non-disintegrated particles are separated by wet sieving. In step 40, the solids are then separated from the liquid phase. Then, two alcohol washing steps 50 and 70 are performed with subsequent solid-liquid separation by means of decanters 60 and 80. In step 100, finally, the fibers are gently dried by fluidized bed drying so as to obtain the citrus fibers used according to the invention 110.

### B. Preparation of an Activatable, Pectin-Containing Apple Fiber

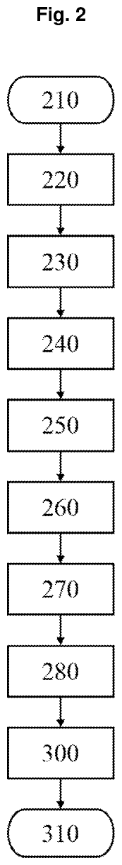

FIG. 2 is a schematic representation of a method of preparing the activatable, pectin-containing apple fiber in the form of a flowchart. Starting from the apple pommace 210, the pommace is disintegrated by hydrolytic 220 incubation in an acidic solution at 70° to 80° C. The material in the form of an aqueous suspension is then subjected to a single-stage or multi-stage separation step 230 to remove coarse particles, which finally involves separating the material thus obtained, freed from coarse particles, from the aqueous suspension (also part of step 230). In the case of a multi-stage separation of coarse particles, this is preferably done with sieve drums of different sieve mesh sizes. In step 240, the material freed from coarse particles is washed with water and the washing liquid is separated by means of a solid-liquid separation. Then, two alcohol washing steps 250 and 270 are performed with subsequent solid-liquid separation by means of decanters 260 and 280. In step 300, finally, the fibers are gently dried by fluidized bed drying so as to obtain the apple fibers used according to the invention 310.

### C. Preparation of an Activated, Pectin-Containing Apple Fiber

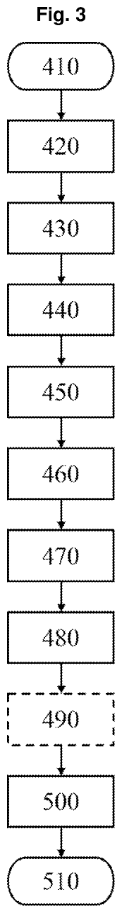

FIG. 3 is a schematic representation of a method of preparing the activated, pectin-containing apple fiber used according to the invention in the form of a flowchart. Starting from the apple pommace 410, the pommace is disintegrated by hydrolytic 420 incubation in an acidic solution at 70° to 80° C. The material in the form of an aqueous suspension is then subjected to a single-stage or multi-stage separation step 430 to remove coarse particles, which finally involves separating the material thus obtained, freed from coarse particles, from the aqueous suspension (also part of step 430). In the case of a multi-stage separation of coarse particles, this is preferably done with sieve drums of different sieve mesh sizes. In step 440, the material freed from coarse particles is washed with water and the washing liquid is separated by means of a solid-liquid separation. Then, two alcohol washing steps 450 and 470 are performed with subsequent solid-liquid separation by means of decanters 460 and 480. In an optional step 490, any residual alcohol can be removed by blowing in water vapor. In step 500, finally, the fibers are gently dried by vacuum drying so as to obtain the apple fibers 510.

### D. Preparation of an Activated, Pectin-Containing Citrus Fiber

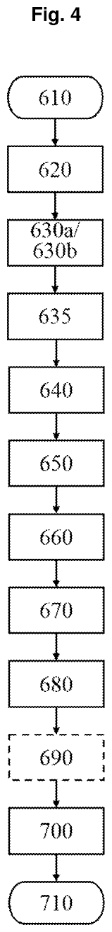

FIG. 4 is a schematic representation of a method of preparing the activated, pectin-containing citrus fiber used according to the invention in the form of a flowchart. Starting from the citrus pulp 610, the pulp is disintegrated by hydrolytic 620 incubation in an acidic solution at 70° to 80° C. Two separate steps 630a (decanter) and 630b (separator) follow for as complete a separation of all particles from the liquid phase as possible. The separated material is washed with an aqueous solution 635. From the washing mixture thus obtained, coarse or non-disintegrated particles are separated by wet sieving. In step 640, the solids are then separated from the liquid phase by means of a decanter. Then, two alcohol washing steps 650 and 670 are performed with subsequent solid-liquid separation by means of decanters 660 and 680. In an optional step 690, any residual alcohol can be removed by blowing in water vapor. In step 700, finally, the fibers are gently dried by vacuum drying so as to obtain the citrus fibers 710.

### 2 Test Method for Determining the Yield Point (Rotational Measurement)

### Measurement Principle:

This yield point is an indicator of the structural strength and is determined by rotational measurement, by increasing the shear stress acting on the sample over time until the sample begins to flow.

Shear stresses below the yield point merely cause an elastic deformation; it is only shear stresses above the yield point that will cause the sample to flow. This value is determined by measuring when a defined minimum shear rate γ is exceeded. According to the present method, the yield point to [Pa] is exceeded at shear rate γ≥0.1 s⁻¹.

| | |
|---|---|
| measuring device: | Rheometer Physica MCR series |
| | (e.g. MCR 301, MCR 101) |
| measuring system: | Z3 DIN or CC25, respectively |
| measuring vessel: | CC 27 P06 (ribbed measuring vessel) |
| number of measuring stages: | 3 |
| measuring temperature: | 20° C. |

measuring parameters:

### 1^{st} Stage (Resting Period):

| | | |
|---|---|---|
| stage settings: | default parameter: | shearing stress [Pa] |
| | value: | 0 Pa constant |

| | | |
|---|---|---|
| stage duration : | 180 | s |
| temperature: | 20° | C. |

### 2^{nd} Stage (Determining of Yield Point):

| | | |
|---|---|---|
| stage settings: | default parameter: | shearing stress [Pa] |
| | profile: | ramp log. |

| | | |
|---|---|---|
| initial value: | 0.1 | Pa |
| final value: | 80 | Pa |
| stage duration: | 180 | s |
| temperature: | 20° | C. |

### Evaluation:

The yield point To (unit [Pa]) is read out in stage 2 and is the shearing stress (unit: [Pa]) at which the shear rate is for the last time γ≤0.10 s⁻¹.

The yield point measured with the rotation method is also called “yield point rotation”.

The yield point rotation was measured using a fiber suspension (the fiber was simply stirred in with a spoon=corresponding to a non-activated fiber) and is also called “yield point rotation II” within the context of the invention. The yield point is also measured using a fiber dispersion (stirred in under the effect of high shearing forces, e. g. with Ultra Turrax=corresponding to an activated fiber) and is also called “yield point rotation I” within the context of the invention.

### 3 Test Method for Determining the Yield Point (Oscillation Measurement)

### Measurement Principle:

This yield point is also an indicator of the structural strength and is determined in an oscillation test by increasing the amplitude at constant frequency until the sample is destroyed due to the ever-increasing excursion and starts to flow.

Below the yield point, the substance behaves like an elastic solid, i. e. the elastic portions (G′) amount to a larger portion than the viscous portions (G″) whereas when the yield point is exceeded, the viscous portions of the sample increase and the elastic portions decrease.

By definition, the yield point is exceeded at the amplitude when the amount of viscous portions equals that of elastic portions; G′=G″ (cross-over); the corresponding shear stress is the respective measured value.

| | |
|---|---|
| measuring device: | Rheometer Physica MCR series |
| | (e.g. MCR 301, MCR 101) |
| measuring system: | Z3 DIN or CC25, respectively |
| measuring vessel: | CC 27 P06 (ribbed measuring vessel) |

### Measuring Parameters:

| stage settings: | amplitude defaults: | deformation [%] |
|---|---|---|
| | profile: | ramp log. |
| | value: | 0.01-1000% |

| | | |
|---|---|---|
| frequency: | 1.0 | Hz |
| temperature: | 20° | C. |

### Evaluation:

By means of the rheometer software Rheoplus, the shear stress at cross-over is evaluated after the linear viscoelastic range has been exceeded.

The yield point measured with the oscillation method is also called “yield point cross-over”.

The yield point cross-over was measured using a fiber suspension (the fiber was simply stirred in with a spoon=corresponding to a non-shear-activated fiber) and is also termed “yield point cross-over II” within the framework of the invention. The yield point was additionally measured using a fiber dispersion (stirred in under the effect of high shearing forces, e. g. with Ultra Turrax=corresponding to a shear-activated fiber) and is also called “yield point cross-over I” in the context of the invention.

Measuring Results and their Implications:

If the yield point of the suspensions of the fibers used according to the invention, stirred in with a spoon (corresponding to a non-activated fiber), is compared to that of a fiber dispersion stirred in under high shearing forces, such as Ultra Turrax (corresponding to an activated fiber), a statement on the advantage/necessity of an activation can be made. The measuring results are summarized in the table below.

As can be expected, the yield point increases by shear activation in the dispersion.

For the activatable pectin-containing citrus fiber, it was found that due to the relatively low yield point of the fiber suspension at τₒ II=0.8 Pa, full implementation of the fiber properties required activation of the fiber to obtain the desired creamy texture

For the activatable pectin-containing apple fiber, it was found that due to the relatively low yield point of the fiber suspension with τₒ II=0.3 Pa, activation of the fiber is required for full implementation of the fiber properties.

For the activated pectin-containing apple fiber, it was found that due to the relatively low yield point of the fiber suspension with τₒ II=0.1 Pa, activation of the fiber is required for full implementation of the fiber properties.

As expected, the yield point of the activated pectin-containing citrus fiber also increases due to the shear activation in the dispersion. However, the fiber suspension also has a yield point which, at τₒ II>1.5 Pa, is sufficiently high to achieve a creamy texture. Therefore, activation of the fiber is not absolutely necessary.

| | Rotation | | Cross Over | | |
|---|---|---|---|---|---|
| | τₒ | τₒ | τₒ | τₒ | |
| | II [Pa] | I [Pa] | II [Pa] | I [Pa] | |
| | Suspen- | Disper- | Suspen- | Disper- | |
| fiber | sion | sion | sion | sion | activation |
| Activatable | 0.8 | 3.0 | 0.6 | 3.4 | required |
| pectin- | | | | | |
| containing | | | | | |
| citrus | | | | | |
| fiber | | | | | |
| Activatable | 0.3 | 2.1 | 0.4 | 2.3 | required |
| pectin- | | | | | |
| containing | | | | | |
| apple | | | | | |
| fiber | | | | | |
| Activated | 0.1 | 6.7 | 0.2 | 6.5 | required |
| pectin- | | | | | |
| containing | | | | | |
| apple | | | | | |
| fiber | | | | | |
| Activated | 2.3 | 6.9 | 1.8 | 7.2 | Not |
| pectin- | | | | | necesserily |
| containing | | | | | required |
| citrus | | | | | |
| fiber | | | | | |

### 4 Testing Method for Determining the Dynamic Weissenberg Number

### Measuring Principle and Meaning of the Dynamic Weissenberq Number:

The dynamic Weissenberg number W′ (Windhab E, Maier T, Lebensmitteltechnik 1990, 44: 185f) is a derived variable in which the elastic portions (G′) determined in the linear viscoelastic range are related to the viscous portions (G″) in an oscillation test:

$${W}^{′} = \frac{{G}^{′} ( ω )}{{G}^{″} ( ω )} = \frac{1}{tan δ}$$

The dynamic Weissenberg number is a variable which correlates particularly well with the sensorial perception of consistency and can be regarded quite independently from the absolute firmness of the sample.

A high value of W′ means that the fibers have a predominantly elastic structure, whereas a low value of W′ indicates structures with clearly viscous portions. The creamy texture typical of fibers is achieved if the W′ values lie within a range of approximately 6-8; if the values are lower, the sample is assessed to be aqueous (thickened less strongly).

### Material and Methods:

| | |
|---|---|
| measuring device: | Rheometer Physica MCR series, |
| | e.g. MCR 301, MCR 101 |
| measuring system: | Z3 DIN or CC25 |
| measuring vessel: | CC 27 P06 (ribbed measuring vessel) |

### Measuring Parameters:

| stage settings: | amplitude defaults: | deformation [%] |
|---|---|---|
| | profile: | ramp log |
| | value: | 0.01-1000% |

| | | |
|---|---|---|
| frequency: | 1.0 | Hz |
| temperature: | 20° | C. |

### Evaluation:

The angle of phase difference δ is read out within the linear viscoelastic range. Subsequently, the dynamic Weissenberg number W′ is calculated with the following formula:

$${W}^{′} = \frac{1}{tan δ}$$

Measurement Results and their Meaning:

If one considers the dynamic Weissenberg number W′ for the suspension of a fiber used according to the invention, stirred in with a spoon (corresponding to a non-shear activated fiber), with a fiber dispersion stirred in with high shear forces, e.g. Ultra Turrax (corresponding to an activated fiber), one can make a statement about the texture and, moreover, about the necessity of activation. The measurement results are summarized in the following table.

The activatable pectin-containing citrus fiber according to the invention is in the ideal range with W′ values of 7.2 in the suspension and 7.5 for the dispersion and thus exhibits an optimum texture. It is of creamy texture in both cases. The results on the dynamic Weissenberg number show that, with regard to the desired creamy texture, activation of the fiber is not absolutely necessary.

The activatable pectin-containing apple fiber according to the invention is in the suboptimal range with a W′ value of 4.8 in suspension and is in the ideal range only as a dispersion with a W′=5.9 Thus, the activatable apple fiber exhibits an optimal texture only in dispersed form. The results for the dynamic Weissenberg number show that, with regard to the desired creamy texture, activation of the fiber is required.

The activated pectin-containing apple fiber according to the invention with the W′ values of 5.0 in suspension is in the suboptimal range, only as a dispersion with W′=9.2 in the ideal range and thus exhibits an optimal texture only in dispersed form. The results on the dynamic Weissenberg number show that, with regard to the desired creamy texture, an activation of the fiber is required.

The activated pectin-containing citrus fiber according to the invention is in the ideal range with die W′ values of 8.1 in the suspension and 7.3 for the dispersion and thus exhibits an Optimum texture. It is of creamy texture in both cases. Thus, the results for the dynamic Weissenberg number also show that activation of the fiber is not absolutely necessary.

| | W′ | W′ | |
|---|---|---|---|
| Fiber | Suspension | Dispersion | Texture |
| Activatable | 7.2 | 7.5 | creamy with and |
| pectin- | | | without activation, |
| containing | | | viscosity/yield |
| citrus fiber | | | point is regulated |
| | | | via dosage |
| Activatable | 4.8 | 5.9 | Creamy only after activation, |
| pectin- | | | viscosity/yield |
| containing | | | point is regulated |
| apple fiber | | | via dosage |
| Activated | 5.0 | 9.2 | Creamy only after activation, |
| pectin- | | | viscosity/yield |
| containing | | | point is regulated |
| apple fiber | | | via dosage |
| Activated | 8.1 | 7.3 | creamy with and |
| pectin- | | | without activation, |
| containing | | | viscosity/yield |
| citrus fiber | | | point is regulated |
| | | | via dosage |

### 5. Testing Method for Determining the Firmness

### Implementation:

150 ml distilled water are introduced into a beaker. Then 6.0 g of citrus fibers or 9.0 g of apple fibers are stirred into the water with a spoon without formation of lumps. For swelling, this fiber-water mixture is left to stand for 20 min. The suspension is then transferred into a vessel (Ø 90 mm). Subsequently, the firmness is measured with the following method:

| | |
|---|---|
| Measuring device: | Texture Analyser TA-XT 2 (company Stable |
| | Micro Systems, Godalming, UK) |

Testing method/option: measuring of force in the direction of pressure/simple test

| | |
|---|---|
| Parameters: | testing speed: 1.0 mm/s |
| | distance: 15.0 mm/s |
| Measuring tool: | P/50 |

The firmness corresponds to the force required by the measuring bob to penetrate into the suspension by 10 mm. This force is then read out from the force-time diagram.

### 6. Testing Method for Determining Particle Size

### Measurement Principle:

In a sieving machine, a set of sieves with a mesh width continuously increasing from the lower sieve to the upper sieve is arranged on top of each other. The sample is placed on the top sieve, i. e. the sieve with the largest mesh width. The sample particles with a diameter larger than the mesh width remain on the sieve; the finer particles fall onto the sieve below it. The portion of sample on the various sieves is weighed and indicated as a percentage.

### Implementation:

The sample is weighed in to the second decimal digit. The sieves are provided with sieving aids and stacked on top of each other with the mesh width increasing. The sample is quantitatively transferred onto the top sieve; the sieves are clamped in, and the sieving process is performed according to defined parameters. The individual sieves are weighed with the sample and the sieving aid as well as empty with the sieving aid. If for a product, only a limit value within the particle size spectrum is to be tested (e. g. 90%<250 μm), only a sieve with the respective mesh width is used.

### Measuring Defaults:

| sample amount: | 15 | g |
|---|---|---|
| sieving aids: | 2 per sieve bottom | |
| sieving machine: | AS 200 digit, Retsch GmbH company | |
| sieving movement: | three-dimensional | |
| oscillation height: | 1.5 | mm |
| sieving duration: | 15 | min |

The sieve structure consists of the following mesh widths in μm: 1400, 1180, 1000, 710, 500, 355, 250, 150, followed by the bottom. For the activated pectin-containing citrus fibers, a 150 μm sieve is also used.

The particle size is calculated using the following formula:

$$portion per sieve in \% = \frac{final weight in g on the sieve \times 100}{initial sample weight in g}$$

### 7. Preparation of a 2.5 wt % Fiber Dispersion

### Formula:

2.5 g fiber material
97.5 g demineralized water (room temperature)
duration of sprinkling: 15 seconds

The respective amount of demineralized water (room temperature) is introduced into a 250 ml beaker. The exactly weighed amount of fiber is slowly and directly poured into the stirring maelstrom with the stirring unit (Ultra Turrax) running at 8000 rpm (level 1). The sprinkling duration depends on the amount of fibers; it is to last 15 seconds per 2.5 g of sample. Then the dispersion is stirred for exactly 60 seconds at 8000 rpm (level 1). If the sample is to be used for determining viscosity or for measuring the yield point I (rotation), the yield point I (cross-over) or for measuring the dynamic Weissenberg number, it is placed in a temperature-controlled water bath at 20° C.

For measuring viscosity or for measuring the yield point I (rotation), the yield point I (cross-over) or for measuring the dynamic Weissenberg number, the sample is carefully given, after exactly 1 hour, into the measurement system of the rheometer, and the respective measurement is started. If the sample settles, it is carefully stirred up by means of a spoon directly before bottling.

### 8. Preparation of a 2.5 wt % Fiber Suspension

### Formula:

2.5 g fiber material
97.5 g demineralized water (room temperature)

The respective amount of demineralized water (room temperature) is introduced into a 250 ml beaker. The exactly weighed amount of fiber is slowly poured in with a plastic spoon under constant stirring. Then the suspension is stirred until all fibers are watered. If the sample is to be used for determining viscosity or for determining the yield point II (rotation), the yield point II (cross-over) or for determining the dynamic Weissenberg number, it is placed in a temperature-controlled water bath at 20° C.

For measuring viscosity or for measuring the yield point II (rotation), the yield point II (cross-over) or for measuring the dynamic Weissenberg number, the sample is carefully filled into the measurement system of the rheometer after exactly 1 hour, and the measurement is started. If the sample settles, it is carefully stirred up by means of a spoon directly before bottling.

### 9. Test Method for Determining Water Binding Capacity

### Implementation for Water Binding Capacity of Non-Pretreated Samples:

The sample is left to swell over 24 hours with a water excess at room temperature. After centrifugation and subsequent decanting of the supernatant, the water binding capacity can be gravimetrically determined in g H₂O/g sample. The pH value in the suspension is to be measured and documented.

The following parameters are to be observed:

### Weighed Portions:

| plant fiber: | 1.0 g (in centrifuge tube) | |
|---|---|---|
| water addition: | 60 | ml |
| centrifugation: | 4000 | g |
| duration of centrifugation: | 10 | min |

20 minutes after beginning of centrifugation (i. e. 10 minutes after the end of centrifugation), the water supernatant is separated from the welled sample. The sample with the bound water is weighed.

The water binding capacity (WBC) in g H₂O/g sample can now be calculated with the following formula:

$$WBC ( g {H}_{2} O / g sample ) = \frac{sample with bound water ( g ) - 1. g}{1. g}$$

### 10. Test Method for Determining the Viscosity

| measuring device: | Physica MCR series (e.g. MCR 301, MCR 101) |
|---|---|
| measuring system: | Z3 DIN or CC25 (note: the measuring systems |
| | Z3 DIN and CC25 are identical) |
| number of stages: | 4 |

### Measuring Parameters:

### 1^{st} Stage:

| | | |
|---|---|---|
| stage settings: | default parameter: | shearing speed [s⁻¹] |
| | profile: | constant |

| | | |
|---|---|---|
| value: | 0 | s⁻¹ |
| stage duration: | 60 | s |
| temperature: | 20° | C. |

### 2^{nd} Stage:

| | | |
|---|---|---|
| stage settings: | default parameter: | shearing speed [s⁻¹] |
| | profile: | ramp lin |

| | | |
|---|---|---|
| value: | 0.1-100 | s⁻¹ |
| stage duration: | 120 | s |
| temperature: | 20° | C. |

### 3^{rd} Stage:

| | | |
|---|---|---|
| stage settings: | default parameter: | shearing speed [s⁻¹] |
| | profile: | constant |

| | | |
|---|---|---|
| value: | 100 | s⁻¹ |
| stage duration: | 10 | s |
| temperature: | 20° | C. |

### 4^{th} Stage:

| | | |
|---|---|---|
| stage settings: | default parameter: | shearing speed [s⁻¹] |
| | profile: | ramp lin |

| | | |
|---|---|---|
| value: | 100-0.1 | s⁻¹ |
| stage duration: | 120 | s |
| temperature: | 20° | C. |

### Evaluation:

The viscosity (unit [mPas]) is read out as follows: 4^{th} stage at =50 s⁻¹

### 11. Testing Method for Determining the Degree of Esterification

This method corresponds to the method published by JECFA (Joint FAO/WHO Expert Committee on Food Additives). Other than in the JECFA method, however, the deashed pectin is not dissolved in the cold, but heated. Isopropanol instead of ethanol is used as the alcohol.

### 12. Testing Method for Determining the Dietary Fiber Content

This method substantially corresponds to the one published by the AOAC (Official Method 991.43: Total, Soluble and Insoluble Dietary Fiber in Foods; Enzymatic-Gravimetric Method, MES-TRIS Buffer, First Action 1991, Final Action 1994). The only difference is that isopropyl alcohol was used here instead of ethanol.

### 13. Testing Method for Determining Moisture and Dry Mass

### Principle:

The moisture content of the sample is understood to be the reduction in mass after drying, determined according to defined preconditions. The moisture content is determined by means of infrared drying with the moisture analyzer Sartorius MA-45 (Sartorius company, Göttingen, Federal Republic of Germany).

### Implementation:

Approximately 2.5 g of the fiber sample are weighed in on the Sartorius moisture analyzer. The settings of the device can be found in the respective factory measuring instructions. For measuring, the samples are to have approximately room temperature. The moisture content is automatically indicated in percent [% M] by the device. The content of dry substance is automatically indicated in percent [% S] by the device.

Es werden ca. 2.5 g der Faserprobe auf den Sartorius Feuchtebestimmer eingewogen. Die Einstellungen des Gerates sind den entsprechenden werkseitigen Messvorschriften zu entnehmen. Die Proben sollen zur Bestimmung etwa Raumtemperatur haben. Der Feuchtigkeitsgehalt wird vom Gerst automatisch in Prozent [% M] angegeben. Der Trockensubstanzgehalt wird vom Gerät automatisch in Prozent [% S] angegeben.

### 14. Testing Method for Determining Color and Lightness

### Principle:

The measurements of color and lightness are performed with the Minolta Chromameter CR 300 or CR 400, respectively. The spectral characteristics of a sample are determined using tristimulus values. The color of a sample is described using the hue, the lightness and saturation. With these three basic properties, the color can be represented three-dimensionally.

The hues are located on the external face of the color solid; the lightness changes on the vertical axis and the degree of saturation horizontally. If the L*a*b* measurement system is employed, L* represents lightness whereas a* and b* indicate both the hue and the saturation. a* and b* indicate the positions on two color axes, with a* being assigned to the red-green axis and b* being assigned to the blue-yellow axis. For indicating the color measurement values, the device converts the tristimulus values into L*a*b* coordinates.

### Performance of Measurement:

The sample is sprinkled on a white sheet of paper and flattened with a glass plug.

For measurement, the measuring head of the chromameter is directly placed on the sample and the trigger is actuated. A triple measurement is performed of each sample and the average value calculated. The L*, a* and b* values are indicated by the device with two decimals.

### 15. Testing Method for Determining Water-Soluble Pectin in Fiber-Containing Samples

### Measurement Principle:

By aqueous extraction, the pectin contained in fiber-containing samples is converted into the liquid phase. By the addition of alcohol, the pectin is precipitated from the extract as an alcohol-insoluble substance (AIS).

### Extraction:

10 g of the sample to be examined is weighed into a glass bowl. 390 g of boiling distilled water is introduced into a beaker, and the previously weighed sample is stirred into it for 1 minute at the maximum level with Ultra-Turrax.

The sample suspension cooled to ambient temperature is divided over four 150 ml-centrifuge beakers and centrifuged over 10 min at 4000×g. The supernatant is collected. The sediment of each beaker is re-suspended with 50 g of distilled water and again centrifuged over 10 min at 4000×g. The supernatant is collected, the sediment discarded.

The combined centrifugates are added to approximately 4 l of isopropanol (98%) for precipitation of the alcohol-insoluble substance (AIS). After ½ hour, filtration takes place by a filter cloth and the AIS is manually pressed out. In the filter cloth, the AIS is then added to approximately 3 l of isopropanol (98%) and manually, with use of gloves, loosened.

The pressing procedure is repeated, the AIS quantitatively removed from the filter cloth, loosened and dried at 60° C. in a drying oven for 1 hour.

0.1 g of the dried substance which has been pressed out is weighed for calculation of the alcohol-insoluble substance (AIS).

### Calculation:

Calculation of the water-soluble pectin, with reference to the fiber-containing sample, is performed according to the following formula, with the water-soluble pectin being precipitated as the alcohol-insoluble substance (AIS):

$$AIS in the sample in wt \% ( \frac{g}{100 g} ) = \frac{dried AIS [ g ] \times 100}{initial sample weight in g}$$

16. 16. Making a Light Sauce with Flavor of Chicken and Green Pepper

### Ingredients:

72 g base component a. Symphony “Mise en Place” Type light (company herbacuisine)
30 g fine texture component Symphony “a la Carte” Type chicken (company herbacuisine)
20 g refinement component Green peppercorns, pickled 900 ml water

### Base Component a. (Light Base Sauce)

A base component a. with the flavor light base sauce was provided on the basis of the following ingredients: 25 wt % BASIC dry hell® (company herba cuisine; proportion of activatable plant fiber containing pectin 83 wt %, based on the total weight of BASIC dry hell), 75 wt % of other ingredients, namely 37.5 wt % cream powder, 12.5 wt % milk powder, 5.6 wt % carrot powder, 5 wt % leek powder, 3.8 wt % onion powder, 1.9 wt % celery powder, 2.5 wt % light sauce with meat flavoring.

72 g base component a. was added to 900 ml water and mixed with the water.

Subsequently, a fine texture component b. (chicken type) was provided with the following ingredients: 83 wt % water, 10 wt % aroma and 7 wt % activated citrus fiber containing pectin.

30 g of fine texture component b. was added to the mixture of base component a. in water prepared above and the mixture was further stirred. The mixture is heated to above 80° C. for at least 2 minutes and mixed at the highest level for one minute with the aid of a mixing rod and heated again to above 80° C.

Finally, 20 g of green pickled peppercorns was added to the mixture as a refining component c. After further stirring for a period of at least one minute, a sauce with flavors of light base sauce, chicken and green pepper was obtained.

As can be seen from the manufacturing process presented, the multi-component system according to the invention can be used to produce sauces and soups with different flavor and viscosity properties in a simple and straightforward manner.

### LIST OF REFERENCE NUMBERS

10 citrus pulp
20 hydrolysis (disintegration) by incubation in an acidic environment
30a 1^{st} solid-liquid separation decanter
30b 2^{nd} solid-liquid separation separator
35 washing mixture with wet sieving
40 solid-liquid separation
50 1^{st} washing with alcohol
60 solid-liquid separation
70 2^{rd} washing with alcohol
80 solid-liquid separation
100 fluidized bed drying
110 obtained activatable, pectin-containing citrus fiber
210 apple pomace
220 hydrolysis (disintegration) by incubation in an acidic environment
230 (one- or multi-stage) separation of coarse particles with separation of the cleaned material from the aqueous suspension
240 washing with water and solid-liquid separation
250 1^{st} washing with alcohol
260 solid-liquid separation
270 2^{rd} washing with alcohol
280 solid-liquid separation
300 fluidized bed drying
310 obtained activatable, pectin-containing apple fiber
410 apple pomace
420 hydrolysis (disintegration) by incubation in an acidic environment
430 (one- or multi-stage) separation of coarse particles with separation of the cleaned material from the aqueous suspension
440 washing with water and solid-liquid separation
450 1^{st} washing with alcohol
460 solid-liquid separation
470 2^{nd} washing with alcohol
480 solid-liquid separation
490 optional introduction of water vapor
500 fluidized bed drying
510 obtained activated, pectin-containing apple fiber
610 citrus pulp
620 hydrolysis by incubation in an acidic environment
630a 1^{st} solid-liquid separation decanter
630b 2^{nd} A solid-liquid separation separator
635 washing mixture with wet sieving
640 solid-liquid separation decanter
650 1^{st} washing with alcohol
660 solid-liquid separation decanter
670 2^{nd} washing with alcohol
680 solid-liquid separation decanter
690 optional introduction of water vapor
700 vacuum drying
710 obtained activated, pectin-containing citrus fiber

1-23. (canceled)

24. A multi-component system for preparing a sauce and/or a soup containing as separate components:
a. a base component which comprises as liquid binder an activatable pectin-containing citrus fiber, wherein the activatable pectin-containing citrus fiber comprises less than 10 wt % of water-soluble pectin and has a yield point I (rotation) in the fiber dispersion of 1.0-4.0 Pa measured by the measurement method described in embodiment 2,
and has one or more of the following properties:
i. a yield point II (rotation) in the fiber suspension of 0.1-1.0 Pa, advantageously from 0.3-0.9 Pa and particularly advantageously from 0.6-0.8 Pa, measured according to the measuring method described under embodiment 2 described in embodiment example 2;
ii. a yield point II (cross over) in the fiber suspension of 0.1-1.0 Pa, advantageously from 0.3-0.9 Pa and particularly advantageously from 0.6-0.8 Pa, measured according to the measuring method described in embodiment 3.
iii. a yield point I (rotation) in the fiber dispersion of 1.5-3.5 Pa and advantageously from 2.0-3.0 Pa, measured according to the measurement method described under embodiment example 2;
iv. a yield point I (cross over) in the fiber dispersion of 1.0-4.5 Pa, advantageously from 1.5-4.0 Pa and particularly advantageously from −2.0-3.5 Pa, measured according to the measuring method described in embodiment 3;
v. a dynamic Weissenberg number in the fiber suspension of 4.5-8.0, advantageously of 5.0-7.5, particularly advantageously from 7.0-7.5 measured according to the measuring method as described in embodiment 4 measurement method;
vi. a dynamic Weissenberg number in the fiber dispersion of 5.0-9.0, advantageously from 6.0-8.5 and particularly advantageously from 7.0-8.0 measured by the measuring method described in embodiment 4 measuring method;
vii. having a firmness in a 4 wt % aqueous suspension of between 60 g and 240 g, preferably of between 120 g and 200 g and particularly preferably of between 140 and 180 g;
viii. having a viscosity of from 150 to 600 mPas, preferably from 200 to 550 mPas, and particularly preferably from 250 to 500 mPas, wherein the activatable pectin-containing citrus fiber is dispersed in water as a 2.5 wt % solution and the and the viscosity is increased at a shear rate of 50 s⁻¹ at 20° C. is measured;
ix. a water binding capacity of more than 20 g/g, preferably of more than 22 g/g, particularly preferred of more than 24 g/g, and especially preferred of between 24 and 26 g/g;
x. in 1.0 wt % aqueous suspension, a pH of from 3.1 to 4.75 and preferably from 3.4 to 4.2;
xi. a particle size in which at least 90 wt % of the particles are smaller than 450 μm, preferably at least 90 wt % of the particles are smaller than 350 μm and particularly preferably at least 90 wt % of the particles are smaller than than 250 μm;
xii. a lightness value of L*>84, preferably of L*>86 and particularly preferably of L>88;
xiii. a dietary fiber content of the activatable pectin-containing citrus fiber of 80 to 95 wt %;
xiv. less than 8 wt % and advantageously less than 6 wt % of water-soluble pectin;
or
containing as liquid binder an activatable pectin-containing apple fiber, wherein the activatable pectin-containing apple fiber comprises less than 10 wt % of water-soluble pectin and a yield point I (rotation) in the fiber dispersion of 0.75-3.75 Pa measured according to the measuring method described under embodiment 2 and has one or more of the following characteristics:
i. a yield point II (rotation) in the fiber suspension of 0.1 to 1.0 Pa, advantageously from 0.15 to 0.75 Pa and particularly advantageously from 0.25 to 0.5 Pa measured according to the measuring method described in embodiment 2;
ii. a yield point II (cross over) in the fiber suspension of 0.1 to 1.0 Pa, advantageously from 0.15 to 0.75 Pa and particularly advantageously from 0.25 to 0.5 Pa measured according to the measuring method described in embodiment 3. measuring method;
iii. a yield point I (rotation) in the fiber dispersion of 1.0 to 3.5 Pa and advantageously from 1.25 to 3.25 Pa measured by the measurement method described in embodiment example 2;
iv. a yield point I (cross over) in the fiber dispersion of from 0.75 to 4.25 Pa, advantageously from 1.5 to 4.0 Pa and particularly advantageously from 1.75 to 3.75 Pa measured according to the measuring method described in embodiment 3 measuring method;
v. a dynamic WeiBenberg number in the fiber suspension of from 3.0 to 7.0, advantageously from 3.5 to 6.5 Pa and particularly advantageously from 4.5 to 6.0 measured according to the measuring method described in embodiment 4 measuring method;
vi. a dynamic WeiBenberg number in the fiber dispersion of 4.0 to 7.5, advantageously from 4.5 to 7.0, and particularly advantageously from 5.0 to 6.5 measured according to the measuring method described in embodiment 4 measuring method;
vii. has a firmness of from 5 to 100 g, preferably from 20 to 60 g and particularly preferred from 30 to 50 g, wherein the activatable pectin-containing apple fiber is suspended in water as a 6 wt % solution.
viii. having a viscosity of from 50 to 350 mPas, preferably from 75 to 200 mPas, and particularly preferably from 100 to 150 mPas, wherein the activatable pectin-containing apple fiber being dispersed in water as a 2.5 wt % solution and the viscosity is measured at a shear rate of 50 s⁻¹ at 20° C.
ix. a water-binding capacity of more than 19 g/g, preferably of more than 21 g/g, particularly preferred of more than 23 g/g;
x. in 1.0 wt % aqueous suspension, a pH of from 3.5 to 5.0 and preferably from 4.0 to 4.6;
xi. a particle size in which at least 90 wt % of the particles are smaller than 450 μm, preferably at least 90 wt % of the particles are smaller than 350 μm and particularly preferably at least 90% by wt % of the particles are smaller than than 250 μm;
xii. a lightness value L*>54, preferably of L*>55 and particularly preferably of L*>56;
xiii. a dietary fiber content of the activatable pectin-containing apple fiber of 80 to 95 wt %;
xiv. less than 8 wt % and advantageously less than 6 wt % of water-soluble pectin;
b. a fine texture component comprising an activated pectin-containing apple fiber, wherein the activated pectin-containing apple fiber contains less than 10 wt % of water-soluble pectin and a yield point I (rotation) in the fiber dispersion of more than 5.0 Pa measured according to the measuring method described in embodiment 2 and has one or more of the following characteristics:
i. a yield point II (rotation) in fiber suspension of more than 0.1 Pa, advantageously of more than 0.5 Pa, and particularly advantageously of more than 1.0 Pa measured by the measurement method described in embodiment 2;
ii. a yield point I (rotation) in the fiber dispersion of more than 6.0 Pa and advantageously of more than 7.0 Pa measured according to the measuring method described under Embodiment 2 measurement method;
iii. a yield point II (cross over) in fiber suspension of more than 0.1 Pa, advantageously of more than 0.5 Pa and particularly advantageously of more than 1.0 Pa measured according to the measuring method described in embodiment 3 measurement method described;
iv. a yield point I (cross over) in the fiber dispersion of more than 5.0 Pa, advantageously of more than 6.0 Pa and especially advantageously of more than 7.0 Pa measured according to the measurement method described in embodiment example 3;
v. a dynamic Weissenberg number in the fiber suspension of more than 4.0, advantageously of more than 5.0, and particularly advantageously of more than 6.0 measured according to the measuring method described in embodiment 4 measurement method;
vi. a dynamic Weissenberg number in the fiber dispersion of more than 6.5 advantageously of more than 7.5 and particularly advantageously of more than 8.5 measured according to the measurement method described in embodiment 4 measuring method;
vii. a firmness of more than 50 g, preferably of more than 75 g and particularly preferably of more than 100 g, wherein the apple fiber is suspended in water as a 6 wt % solution.
viii. a viscosity of more than 100 mPas, preferably of more than 200 mPas, and more preferably of greater than 350 mPas, wherein the apple fiber is suspended in water as a 2.5 wt % solution and having a viscosity of is measured at a shear rate of 50 s⁻¹ at 20° C.;
ix. a water-binding capacity of more than 20 g/g, preferably of more than 22 g/g, particularly preferably of more than 24 g/g, and especially preferably of more than 27.0 g/g;
x. in 1.0 wt % aqueous suspension, a pH of from 3.5 to 5.0, and preferably from 4.0 to 4.6;
xi. a particle size at which at least 90 wt % of the particles are smaller than 400 μm, preferably smaller than 350 μm and in particular smaller than 300 μm are;
xii. a lightness value L>60, preferably of L*>61 and particularly preferably of L*>62;
xiii. a dietary fiber content of the apple fiber of 80 to 95 wt %;
xiv. less than 8 wt % and advantageously less than 6 wt % of water-soluble pectin;
or
which contains an activated pectin-containing citrus fiber, wherein the activated pectin-containing citrus fiber contains less than 10 wt % of water-soluble pectin, and a yield point I (rotation) in the fiber dispersion of more than 5.5 Pa measured according to the measuring method described in embodiment 2 and has one or more of the following properties:
i. a yield point II (rotation) in the fiber suspension of more than 1.5 Pa and advantageously of more than 2.0 Pa measured according to the measurement method described in Example of embodiment 2;
ii. a yield point II (cross over) in the fiber suspension of more than 1.2 Pa and advantageously of more than 1.5 Pa measured according to the measurement method described under embodiment 3;
iii. a yield point I (rotation) in the fiber dispersion of more than 6.0 Pa measured according to the measuring method described in embodiment 2. measurement method;
iv. a yield point I (cross over) in the fiber dispersion of more than 6.0 Pa and advantageously of more than 6.5 Pa measured according to the measurement method described under Embodiment 3 measurement method;
v. a dynamic Weissenberg number in the fiber suspension of more than 7.0, advantageously of more than 7.5 and particularly advantageously of more than 8.0 measured according to the measuring method described in embodiment 4. measurement method described;
vi. a dynamic Weissenberg number in the fiber dispersion of more than 6.0, advantageously of more than 6.5 and particularly advantageously of more than 7.0 measured according to the measuring method described in embodiment 4 described in embodiment 4;
vii. a firmness in a 4 wt % aqueous suspension of of at least 150 g, particularly advantageously of at least 220 g;
viii. a viscosity of at least 650 mPas, wherein the plant fiber in water as a 2.5 wt % solution, and the viscosity is measured at is measured at a shear rate of 50 s⁻¹ at 20° C.;
ix. a water-binding capacity of more than 22 g/g;
x. in 1.0 wt % aqueous suspension, a pH of from 3.1 to 4.75 and preferably from 3.4 to 4.2;
xi. a particle size in which at least 90 wt % of the particles are smaller than 250 μm, preferably smaller than 200 μm and in particular smaller than 150 μm
xii. a lightness value L>90, preferably of L*>91 and particularly preferably of L*>92;
xiii. a fiber content of the citrus fiber of 80 to 95 wt %;
xiv. less than 8 wt % and particularly advantageously less than 6 wt % of water-soluble pectin;
and
c. optionally a refining component.

25. Multi-component system according to claim 24, characterized in that the base component a. contains a flavor component selected from the group consisting of vegetable powder, for example celery powder, carrot powder, onion powder, leek powder, garlic powder, tomato powder, beetroot powder and mixtures thereof, milk powder, cream powder and mixtures thereof.

26. Multi-component system according to claim 24, characterized in that the base component a. is present as a powder.

27. Multi-component system according to claim 24, characterized in that characterized in that the fine texture component comprises a flavoring agent.

28. Multi-component system according to claim 24, characterized in that characterized in that the fine texture component has a pasty form.

29. Multi-component system according to claim 24, characterized in that the refining component c. is selected from herbs and/or spices, in particular in that the refining component c. is selected from the group consisting of anise, wild garlic, basil, fenugreek, cayenne pepper, chili, cumin, dill, tarragon, fennel, clove, ginger, chamomile, cardamom, garlic, coriander, cumin, turmeric, horseradish, lemon balm, nutmeg, paprika, parsley, bell pepper, peppermint, allspice, saffron, sage, star anise, thyme, vanilla, juniper berries, cinnamon, lemongrass and mixtures thereof.

30. Multi-component system according to claim 24, characterized in that characterized in that the multi-component system contains a proportion of base component a. from 20 to 95 wt %, in particular from 40 to 90 wt % or from 50 to 80 wt %, based on the combined weight of the base component a. and of the fine texture component b.

31. Multi-component system according to claim 24, characterized in that characterized in that the multi-component system has a content of fine texture component b. of from 5 to 80 wt %, in particular from 10 to 60 wt % or from 20 to 50 wt %, based on the combined weight of the base component a. and the fine-texture component b.

32. Multi-component system according to claim 24, characterized in that characterized in that the multi-component system comprises the base component a. as the as liquid binder the activatable apple or citrus fiber in powder form and the fine texture component b. the activated apple or citrus fiber in paste form and the fine texture component has a content of from 5 to 80 wt %, in particular from 10 to 60% by weight or from 20 to 50% by weight, based on the combined weight of the base component a. and the fine texture component b.

33. Use of a multi-component system according to claim 24 for the preparation of a sauce or a soup.

34. Process for preparing a sauce or a soup comprising the steps of:
(1) providing a base component a., a fine texture component b. and, optionally, a refining component c. each defined according to claim 24,
(2) placing the components provided in step (1) in water and mixing, to obtain a mixture,
(3) optionally heating the mixture obtained in step (2).
